(19) United States
(12) Patent Application Publication
(10) Pub. No.: US 2010/0103793 A1
(43) Pub. Date: Apr. 29, 2010

(54) MULTILAYER OPTICAL INFORMATION RECORDING MEDIUM, METHOD FOR RECORDING INFORMATION IN THE MULTILAYER OPTICAL INFORMATION RECORDING MEDIUM, RECORDING/REPRODUCING APPARATUS

(75) Inventors: Atsushi NAKAMURA, Osaka (JP); Naoyasu MIYAGAWA, Hyogo (JP); Shigeru FURUMIYA, Hyogo (JP); Yasumori HINO, Nara (JP); Motoshi ITO, Osaka (JP); Mamoru SHOJI, Osaka (JP); Yoshihisa TAKAHASHI, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(73) Assignee: PANASONIC CORPORATION, Osaka (JP)

(21) Appl. No.: 12/258,562

(22) Filed: Oct. 27, 2008

(51) Int. Cl. G11B 7/00

(52) U.S. Cl. 369/94; 369/275.3; G9B/7

(57) ABSTRACT

The present invention provides a novel physical structure for a multilayer optical information recording medium including a plurality of information recording layers, and a recording method and a recording/reproduction apparatus for such a recording medium using the same. The multilayer optical information recording medium according to the present invention includes a test recording area for performing test recording for data recording and/or reproduction conditions in at least one of an inner zone and an outer zone. The test recording area is categorized as one of at least two categories of test recording areas (OPC-A area and OPC-B area). In the OPC-B area, an upper limit value is set on a recording power for the test recording.

### BACKGROUND OF THE INVENTION

1. Field of the Invention

The present invention relates to a multilayer optical information recording medium including a plurality of, i.e., two or more, information recording layers and including a test recording area (OPC area) for obtaining an optimal recording condition (recording power and write strategy) for at least two recording layers, and a recording method and a recording/reproduction apparatus for a multilayer optical information recording medium.

2. Description of the Related Art

Conventionally, there are standards for optical recording mediums such as BD-R, BD-RE, DVD-RAM, DVD-R, DVD-RW, CD-RW and the like, and there are technologies for recording or reproducing data by irradiating an optical disc conformed to such a standard with laser beam.

One example of such an optical disc uses a phase change recording material for a recording layer. Information recording on a phase change optical disc is performed as follows. An optical disc is irradiated with a laser beam ray, and an atomic bond state of a substance forming a thin film on a recording layer face is locally changed by an energy injected thereto by the laser beam ray. Then, an optical disc is irradiated with laser beam having a sufficiently lower power than the power used for recording. At this point, a reflectance of the light is changed by the above-mentioned difference in the physical state. By detecting such a change of the reflectance, information can be read.

A phase change optical disc is available, in addition to as a rewritable optical disc using GeSbTe for a recording material of a recording layer, as a write-once optical disc using another recording material. Examples of recording materials for write-once optical discs are disclosed in the following document. Japanese Laid-Open Patent Publication No. 2004-362748 discloses a document which describes using a material containing Te—O-M (where M indicates at least one element selected from metal elements, semi-metal elements and semiconductor elements). A recording material Te—O-M is a material containing Te, O and M and is a composite material containing fine particles of Te, Te-M and M dispersed totally randomly in a matrix of TeO₂ immediately after a layer of such a recording material is formed. When a thin film formed of this recording material is irradiated with collected laser beam, the film is melt and Te or Te-M crystals having a large diameter are deposited. A difference in the optical state occurring at this point can be detected as a signal. Thus, so-called write-once recording, i.e., recording which can be performed only once, is realized.

Beside the above-mentioned write-once optical disc, there are other write-once optical discs in which recording marks are formed by the following systems, for example. In one example, two thin films formed of different materials are overlapped with each other and are heated to be melted by laser. As a result, the two materials are mixed together to form an alloy, and thus a recording mark is formed. This system provides, for example, write-once discs using alloy type materials containing inorganic type materials. In another example, a layer of an organic colorant type material is heated by laser irradiation to thermally decompose the organic colorant. The refractive index of the thermally decomposed part is lowered. As compared with a non-recorded part, the layer part through which the light has been transmitted appears to have a shorter optical path. For incident light, the light transmission part appears like convex and concave pits of a reproduction-only CDs or the like. By this, information is recorded.

For recording a mark edge on these write-once optical discs, the discs are irradiated with laser beam modulated into a multi-pulse form. By changing the physical state of the recording material in this manner, a recording mark is formed. Information is read by detecting a change of the reflectance between the recorded mark and the space.

Recently, the capacity of optical discs are increasing. The recording capacity of optical discs can be increased by one of the following manners. The length of marks and spaces and track pitch are decreased to raise the recording density of each recording layer; or the number of information recording layers on which information is writable, or from which information is readable, from the side of a laser beam incident face is raised to increase the recording capacity.

The number of recording layers can be raised to increase the recording capacity by, for example, providing an information recording medium semi-transparent to the laser beam on the laser beam incidence side (the side of the optical disc closer to the light source) and also providing an information recording layer on the opposite side of the optical disc from the laser beam incidence side. An optical disc having a plurality of information recording layers needs to be able to realize recording or reproduction in an appropriate state in all the stacked information recording layers, regardless of the recording state of the information recording layer(s) through which the light has been transmitted. Therefore, it has become more and more important to guarantee the reliability of recording or reproduction signals.

In order to guarantee such reliability, a test recording area, which is also referred to as an “OPC (Optimum Power Control) area”, for calibrating the recording power is provided in an inner zone on an inner periphery side or an outer zone on an outer periphery side of the optical disc. “OPC” means a process of optimizing the power level of the laser pulse irradiating the optical disc (recording power learning), the generation timing and length of the laser pulse (write strategy learning) or the like by performing test recording on a recordable optical disc. The OPC is performed before regular recording is conducted, or in order to calibrate a change of power caused by a temperature change or the like. Specifically, when an optical disc is loaded on a recording/reproduction apparatus (optical disc apparatus), the optical disc apparatus performs test recording repeatedly in an OPC area provided in the optical disc to calculate a recording power optimal for the optical disc.

However, in the process of performing the recording power learning, a test recording may possibly be performed in the OPC area at a recording power excessively higher than the appropriate power for recording data. When test recording is performed in an OPC area of an information recording layer close to the laser beam incidence side at an excessively high recording power, the laser beam which is transmitted through such an information recording layer is influenced by the recording state of the OPC area to exert an adverse effect on the recording/reproduction signal quality of an information recording layer farther from the laser beam incidence side. Specifically, the recording power may be deviated from the optimal recording power, an error may occur in reading a reproduction signal, or a tracking error signal or a focusing error signal may be distorted to make the tracking servo or focusing servo unstable.

In order to solve these problems, technologies have been proposed for improving the physical format of an OPC area of, or the recording method for, a multilayer optical disc in order to increase the reliability of the OPC area (see, for example, Japanese Laid-Open Patent Publication No. 2005-38584, International Publication 2002/023542 pamphlet, PCT National Phase Japanese Laid-Open Patent Publications Nos. 2007-521606, 2007-526595, 2007-521589, and 2008-527602, and “Zukai Blu-ray Disc Dokuhon” (Blu-ray Handbook with Diagrams) published by Ohmsha, Ltd.).

According to a physical format mainly disclosed in the above-listed publications, an OPC area of a conventional multilayer optical disc includes at least two information recording layers. Each of the information recording layers includes an inner zone, a data zone and an outer zone. At least one OPC area is provided in at least one of the inner zone and the outer zone area. However, the OPC areas provided in all the plurality of information recording layers or adjacent information recording layers should not be physically located at the same position with respect to the scanning direction of the light beam.

Nonetheless, in the case where the OPC areas in the odd-numbered or even-numbered information recording layers are overlapped with each other, light which has been transmitted through an information recording layer close to the light incidence side is influenced by the recording state of such a layer and exerts an adverse effect on the recording or reproduction signal quality of an information recording layer farther from the light incidence side. Even with an optical disc in which presence/absence of recorded data on an information recording layer close to the light incidence side does not influence the recording quality of an information recording layer farther from the light incidence side, if test recording is performed in an OPC area of an information recording layer close to the light incidence side at an excessively high power, the laser beam is influenced when passing through such an information recording layer; for example, the intensity of the laser beam is changed. As a result, the optimal recording power may not be derived by the OPC in such an information recording layer far from the light incidence side.

Meanwhile, if the OPC areas are located such that none of the OPC areas are overlapped with each other, the following is required when the number of information recording layers to be stacked increases. In order to prevent the OPC areas from being located physically at the same position with respect to the scanning direction of the light beam, the physical size of the OPC area in each layer needs to be decreased, or the inner zone or outer zone needs to be enlarged. By either method, the number of times of OPC needs to be decreased, or the size of the user data zone in the optical disc which is used by the user for the original purpose of recording data, needs to be decreased. As understood from these, the above-described problems have not been solved.

Especially, even if the OPC areas can be located such that the OPC areas are not overlapped with each other between adjacent information recording layers or among any of the information recording layers without enlarging the inner zone or the outer zone, the physical size (number of clusters) of the OPC areas needs to be decreased as the number of information recording layers increases. Especially in an optical disc medium allowing recording to be done only once, such as a write-once optical disc, as the physical size of the OPC area is decreased, the number of times the recording power or the recording pulse conditions can be learned is decreased. The possibility that the OPC area is used up is also increased. When this occurs, there may be a high possibility that the recording to an optical disc needs to be stopped for the reason that test recording cannot be performed despite the user data zone is not full.

Especially in an optical disc having a higher recording density per face while having a larger number of information recording layers (for example, a BD having a recording capacity of 33.4 GB or 32 GB per layer as a result of increasing the line density), the size of recording marks or spaces becomes significantly smaller than the size of an optical spot. As a result, the inter-code interferences of reproduction signals or thermal interferences between recording marks increase, which generates conspicuous edge shifts between recording marks and spaces. Write strategy adjustment performed for correcting these edge shifts to improve the recording signal quality needs to be performed more accurately by increasing the number of time of test recording. Namely, with a physical format of locating the test recording areas in the inner zone or outer zone so as not to be overlapped with each other as described above, the physical size of the test areas of the information recording layers needs to be decreased and thus many test recording areas cannot be provided.

### SUMMARY OF THE INVENTION

The present invention, made in light of the above-described problems, has an object of providing a physical format of an information recording medium usable for performing test recording in OPC areas provided in a plurality of information recording layers in order to obtain an optimal recording power or to perform write strategy adjustment, the physical format efficiently locating the OPC areas in an inner zone or an outer zone while minimizing the influence by test recording performed on one information recording layer, which is exerted on test recording performed in an OPC area of another information recording layer; and a recording method for a multilayer optical information recording medium and a recording/reproduction apparatus using such a physical format.

In order to solve the above-described problems, a multilayer optical information recording medium according to the present invention is a multilayer optical information recording medium including a plurality of information recording layers, wherein each of the information recording layers includes an inner zone, a data zone and an outer zone located along a radial direction from an inner periphery thereof; the plurality of information recording layers include a first information recording layer, and second through N'th information recording layers (N is an integer of two or larger) which are provided closer to a laser beam incidence side than the first information recording layer and sequentially located from the side closer to the first recording layer; at least one of the first through N'th information recording layers includes a reproduction-only management data area (control data area) pre-formed at the time of production of the disc; each of the first through N'th information recording layers in at least one of the inner zone and the outer zone includes at least one category of test recording area among at least two categories of test recording areas (OPC-A area and OPC-B area) for performing test recording for data recording and/or reproduction conditions; and in the OPC-B area, an upper limit value is set on a recording power for the test recording.

In the multilayer optical information recording medium according to the present invention, in the OPC-B area, the test recording is performed after the test recording is performed in the OPC-A area of any one of the first through N'th information recording layers.

In the multilayer optical information recording medium according to the present invention, the upper limit value in the OPC-B area is set based on a ratio between an optimal recording power which is found in the OPC-A area of at least one of the first through N'th information recording layers, and a recommended recording power which is pre-recorded in the management data area.

In the multilayer optical information recording medium according to the present invention, the OPC-A areas of M'th (M is an integer of equal to or larger than 1 and equal to or smaller than N) through N'th information recording layers, among the first through N'th information recording layers, are partially or entirely located physically at generally the same radial position in an overlapped manner with one another.

In the multilayer optical information recording medium according to the present invention, M is M=1 or M=2.

In the multilayer optical information recording medium according to the present invention, the management data (control data) area is partially or entirely overlapped with the OPC-B area in terms of physical radial position thereof.

In the multilayer optical information recording medium according to the present invention, the test recording area of the first information recording layer has a physical size larger than the physical size of the OPC-A area of each of the second through N'th information recording layers.

In the multilayer optical information recording medium according to the present invention, the OPC-B area has a physical size larger than the physical size of the OPC-A area in the same information recording layer as the OPC-B area.

In the multilayer optical information recording medium according to the present invention, in the management data area, an upper limit value of the recording power for the test recording in the OPC-B area is pre-recorded.

In the multilayer optical information recording medium according to the present invention, in the management data area, an upper limit value of a modulation signal degree with which recording can be performed in the OPC-B area, or a modulation signal degree regarding the recommended recording power is pre-recorded.

In the present invention, the multilayer optical information recording medium is a write-once optical disc.

A recording method according to the present invention is for a multilayer optical information recording medium including a plurality of information recording layers, in which each of the information recording layers includes an inner zone, a data zone and an outer zone located along a radial direction from an inner periphery thereof; the plurality of information recording layers include a first information recording layer, and second through N'th information recording layers (N is an integer of two or larger) which are provided closer to a laser beam incidence side than the first information recording layer and sequentially located from the side closer to the first recording layer; at least one of the first through N'th information recording layers includes a reproduction-only management data area (control data area) pre-formed at the time of production of the disc, and a writable or rewritable management data area (DMA); each of the first through N'th information recording layers in at least one of the inner zone and the outer zone includes at least one category of test recording area among at least two categories of test recording areas (OPC-A area and OPC-B area) for performing test recording for data recording and/or reproduction conditions; and in the OPC-B area, an upper limit value is set on a recording power for the test recording. The method comprises the steps of reading a recommended power pre-recorded at the time of production of the disc from the control data area; reading OPC area management information from the DMA; determining that a recordable OPC-A area is an i'th (i is an integer of 1 through N) information recording layer based on the OPC area management information; performing test recording in the OPC-A area of the i'th information recording layer and determining an optimal recording power for the i'th information recording layer; calculating a ratio (α) between the optimal recording power of the i'th information recording layer and the recommended recording power, calculating a predicted optimal recording power, which is an optimal recording power predicted for an information recording layer other than the i'th information recording layer, and calculating an upper limit value on the recording power for test recording in the OPC-B area in the information recording layer other than the i'th information recording layer based on the predicted optimal recording power; and performing the test recording at a recording power equal to or lower than the upper limit value in the OPC-B area of an arbitrary j'th (j≠i and j is an integer of 1 through N) information recording layer other than the i'th information recording layer, and determining an optimal recording power for the arbitrary j'th information recording layer.

In the recording method for the multilayer optical information recording medium according to the present invention, in the OPC-B area, the test recording is performed after the test recording is performed in the OPC-A area of any one of the first through N'th information recording layers.

In the recording method for the multilayer optical information recording medium according to the present invention, the upper limit value in the OPC-B area is set using a ratio (α) between an optimal recording power which is found in the OPC-A area of the i'th information recording layer, which is at least one of the first through N'th information recording layers, and a recommended recording power which is pre-recorded in the management data area; and based on a value obtained by expression (1):

the predicted optimal power for the j'th layer=α×the recommended recording power for the j'th layer×X (1).

In the recording method for the multilayer optical information recording medium according to the present invention, X is 1.1

In the recording method for the multilayer optical information recording medium according to the present invention, the test recording in the OPC-A areas in the information recording layers is sequentially performed in the order from the OPC-A area of the layer farthest from the laser incidence side to the OPC-A area of the layer closest to the laser incidence side among the recordable OPC-A areas.

In the recording method for the multilayer optical information recording medium according to the present invention, the test recording in the OPC-B areas in the information recording layers is performed in an arbitrary order among recordable OPC-B areas.

In the recording method for the multilayer optical information recording medium according to the present invention, the optical information recording medium including the plurality of information recording layers is a write-once optical disc.

A recording/reproduction apparatus for a multilayer optical information recording medium according to the present invention comprises light irradiation means for irradiating, with laser beam, each information recording layer of the multilayer optical information recording medium including a plurality of information recording layers to record data to, and reproduce data from, the information recording layer; management information reading means for reading a recommended recording power pre-recorded in a reproduction-only disc management area of the multilayer information recording medium at the time of production thereof, and writable or rewritable OPC area management information; recording power control means for controlling a laser power of the laser beam irradiating each information recording layer of the multilayer optical information recording medium to perform test recording at a plurality of recording powers; reproduction signal detection means for detecting a signal quality of a reproduction signal obtained from light reflected by the multilayer optical information recording medium; and calculation means for calculating an optimal recording power, which is an optimal value of the recording power, from a value detected by the reproduction signal detection means, calculating a ratio (α) between the optimal recording power and the recommended recording power, and calculating a predicted optimal recording power, which is an optimal recording power predicted for an arbitrary information recording layer.

In the present invention, the recording/reproduction apparatus according to the present invention comprises memory means for storing any one of, or all of, the optimal recording power for each information recording layer determined by the test recording, the ratio (α), and the predicted optimal recording power.

As described above, according to the present invention directed to a multilayer optical information recording medium, and a recording method and a recording/reproduction apparatus for a multilayer optical information recording medium, the following is realized. For performing test recording in an OPC area in each of a plurality of information recording layers of an multilayer optical disc including the plurality of information recording layers in order to adjust the recording power or the write strategy to be optimal, highly precise recording power adjustment and write strategy adjustment are realized even in an information recording layer far from the laser beam incidence side regardless of the recording state of an information recording layer close to the laser beam incidence side. As a result, a highly reliable multilayer optical disc can be provided.

By arranging the physical format of the test recording areas in a devised manner as described above, the physical size of the OPC areas of each information recording layer can be increased within a limited inner zone or outer zone. Therefore, highly reliable recording power adjustment and write strategy adjustment are realized without decreasing the number of times of test recording. Especially for an optical disc on which recording can be done only once, for example, a write-once optical disc, such a situation can be avoided that the OPC areas are used up although the user data zone is not full. Thus, the problem that, for example, the recording cannot be performed on the optical disc merely because test recording cannot be performed can be solved.

As a result, a large capacity and high density multilayer optical information recording medium is realized while a highly reliable information recording/reproduction apparatus is realized.

### BRIEF DESCRIPTION OF THE DRAWINGS

FIG. 1 shows an overall structure of an optical information recording/reproduction apparatus according to an embodiment of the present invention.

FIG. 2 shows a cross-sectional view of a track layout of each layer of a four-layer optical disc according to an embodiment of the present invention.

FIG. 3 shows an example of a physical format of OPC areas of each information recording layer according to Embodiment 1 of the present invention.

FIG. 4 shows an example of a physical format of OPC areas of each information recording layer according to Embodiment 2 of the present invention.

FIG. 5 shows an example of a physical format of OPC areas of each information recording layer according to Embodiment 3 of the present invention.

FIG. 6 shows an example of a physical format of OPC areas of each information recording layer according to Embodiment 4 of the present invention.

FIG. 7 shows an example of a physical format of OPC areas of each information recording layer according to Embodiment 5 of the present invention.

FIG. 8 is a flowchart showing a procedure of performing test recording in a test recording area of a four-layer optical disc according to one of Embodiments 1 through 4 of the present invention.

FIG. 9 shows an overview of a stacking structure of a four-layer optical disc according to an embodiment of the present invention.

FIG. 10 shows a planar area structure of a multilayer optical disc medium according to an embodiment of the present invention.

FIG. 11 is a flowchart showing a procedure of performing test recording in a test recording area of a four-layer optical disc according to Embodiment 5 of the present invention.

FIG. 12 schematically shows a reproduction signal according to Embodiment 8 of the present invention.

FIG. 13 shows the relationship of the logical product of the modulation signal degree and the recording power, with respect to the recording power.

FIG. 14 shows the directions in which the clusters in the OPC areas are used according to an embodiment of the present invention.

### DETAILED DESCRIPTION OF PREFERRED EMBODIMENTS

Hereinafter, preferable embodiments of a multilayer optical information recording medium, and a recording method and a recording/reproduction apparatus for a multilayer optical information recording medium according to the present invention will be described in detail with reference to the drawings.

In the embodiments of the present invention, a BD-R, which is a write-once optical disc having four layers will be described as a recording medium. This does not specifically limit the characteristics of the recording medium, and a BD-R is operable with a technology common to recording mediums, by which information is recorded by injecting an energy to a recording medium to form a mark or a pit which have different physical properties from those of an un-recorded area. An overview of the physical format of a Blu-ray disc (BD) used in these embodiments is also disclosed in the above-mentioned document (“Zukai Blu-ray Disc Dokuhon” (Blu-ray Handbook with Diagrams) published by Ohmsha, Ltd.).

This technology is also common to a so-called hybrid multilayer optical information recording medium obtained by combining an information recording layer of a reproduction-only optical disc which includes a reflection layer formed on a substrate having concave and convex pits, and either one of an information recording layer of a write-once optical disc and an information recording layer of a rewritable optical disc.

Main optical conditions used in the optical disc, and the recording method and the recording/reproduction apparatus for the optical disc according to the present invention are as follows. The wavelength of laser beam is 400 nm to 410 nm, specifically, 405 nm; and the NA (Numerical Aperture) of the objective lens is 0.84 to 0.86, specifically, NA=0.85. The physical structure of the multilayer optical disc medium is as follows: track pitch is 0.32 μm; four recordable or readable information recording layers are stacked from the laser beam incident face; and the distance from the laser incident face to each information recording face is 50 μm to 110 μm. Recording performed on the optical disc with the coding system of 17PP modulation and the shortest mark length (2T) of 0.112 μm to 0.124 μm, specifically 0.112 μm will be described as an example. When recording is performed with a line density providing a shortest mark length of 0.112 μm, the recording capacity of one layer of a BD having a diameter of 12 cm corresponds to about 33.4 GB. When three such layers are stacked, the recording capacity corresponds to about 100 GB; and when four such layers are stacked, the recording capacity corresponds to about 134 GB. When recording is performed with a line density providing a shortest mark length of 0.116 μm, the recording capacity of one layer of a BD having a diameter of 12 cm corresponds to about 32 GB. When three such layers are stacked, the recording capacity corresponds to about 96 GB; and when four, such layers are stacked, the recording capacity corresponds to about 128 GB. When recording is performed with a line density providing a shortest mark length of 0.124 μ1m, the recording capacity of one layer of a BD having a diameter of 12 cm corresponds to about 30 GB. When three such layers are stacked, the recording capacity corresponds to about 90 GB; and when four such layers are stacked, the recording capacity corresponds to about 120 GB.

In the following example, the recording speed corresponds to BD 2× with a channel rate of 132 MHz (Tw=7.58 ns). The line rate is 7.38 m/sec.

The various parameters shown here (number of layers, layer thickness, recording density, recording capacity, recording speed, etc.) are one example, and the present invention is not limited to these numerical values.

In the present invention, an “OPC (Optimum Power Control) area” means an area assigned for performing test recording (or also referred to as “OPC”) in an inner zone provided on the inner periphery side of a recording medium or an outer zone provided in an outer periphery side of the recording medium. “OPC (Optimum Power Control)” means a process, performed before data recording, of optimizing the recording power level of laser beam which irradiates a recordable optical disc at the time of recording. Specifically, when an optical disc is loaded on a recording/reproduction apparatus (optical disc apparatus), the optical disc apparatus repeatedly executes a process of performing test recording in an OPC area in the optical disc and reproducing a recorded signal to calculate an optimum level for the recording power. The recording power determined in this process is set as the optimal recording power. For recording data, the optical disc is irradiated with laser beam at the optimal recording power. Therefore, a recordable optical disc necessarily includes a test recording area.

In a multilayer optical disc, the transmittance of the laser beam through an information recording layer close to the laser beam incidence side influences the laser beam emission power for performing recording on an information recording layer farther from the laser beam incidence side. In addition, the optimal recording power, the optimal recording pulse conditions and the like are different among individual information recording layers by the difference in the structural elements such as, for example, the composition of the recording material used for the recording film of the information recording layer, and the thickness of the recording layer, protection layer, reflection layer and the like. Therefore, all the information recording layers each need an OPC area.

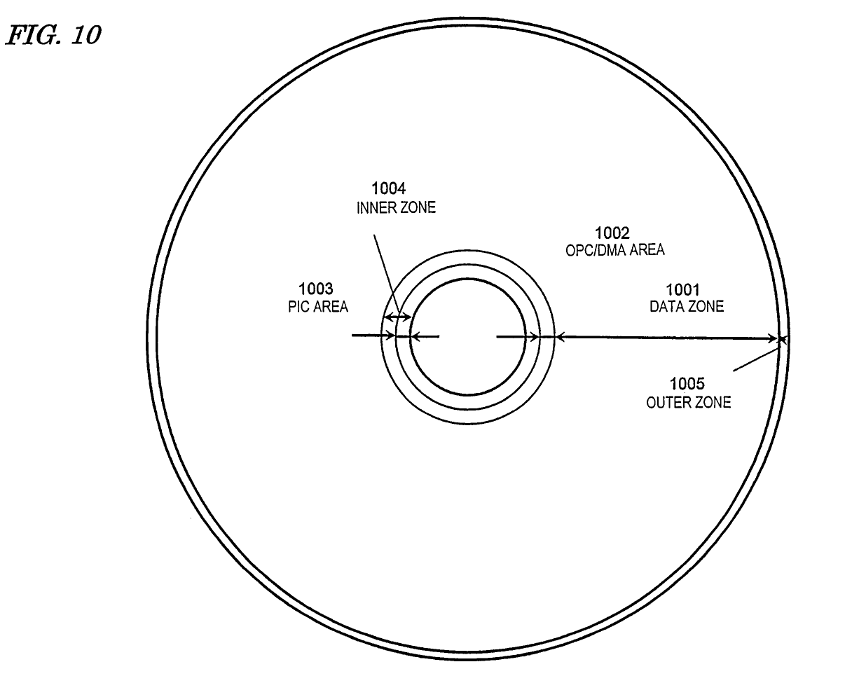

Now, a multilayer optical disc, which is an example of a multilayer optical information recording medium according to the present invention, will be described with reference to the drawings. FIG. 10 shows a planar area structure of a multilayer optical disc medium. An inner zone 1004, a data zone 1001, and an outer zone 1005 are located from an inner periphery of the optical disc medium. In the inner zone 1004, a PIC (Permanent Information & Control data) area 1003 and an OPC/DMA area 1002 are located. The OPC area is used for performing test recording, before data is recorded in the data zone 1001, to obtain a recording power and recording pulse stream conditions which are optimal for the disc or for each information recording layer. The OPC area is occasionally referred to as a “learning area”. The OPC area is also used for performing test recording to make an adjustment for a change caused to the recording power or to the recording pulse stream by an individual variance of the optical disc, or an environmental changes such as a rapid temperature change, adherence of dirt or dust, or the like. The PIC area 1003 is a reproduction-only area and has disc management information recorded therein by modulating a groove at high speed. The disc management information recorded in this area includes OPC parameters required to obtain the optimal recording power, write strategy type, recommended values for the generation timing, length and the like of laser pulses (recording pulse conditions), recording line rate, reproduction power, version number and the like. Although not shown in FIG. 10, an area called a BCA (Burst Cutting Area) inner to the PIC area includes a unique number for medium identification recorded by burning the information face in a bar code form. The unique number is used for copyright protection or the like. The data zone 1001 is used for actually recording data specified by a user, and is also referred to as a “user data zone”. In the outer zone, there is no reproduction-only PIC area, and an OPC/DMA area is located for test recording or for management information of the recorded data, like in the inner zone.

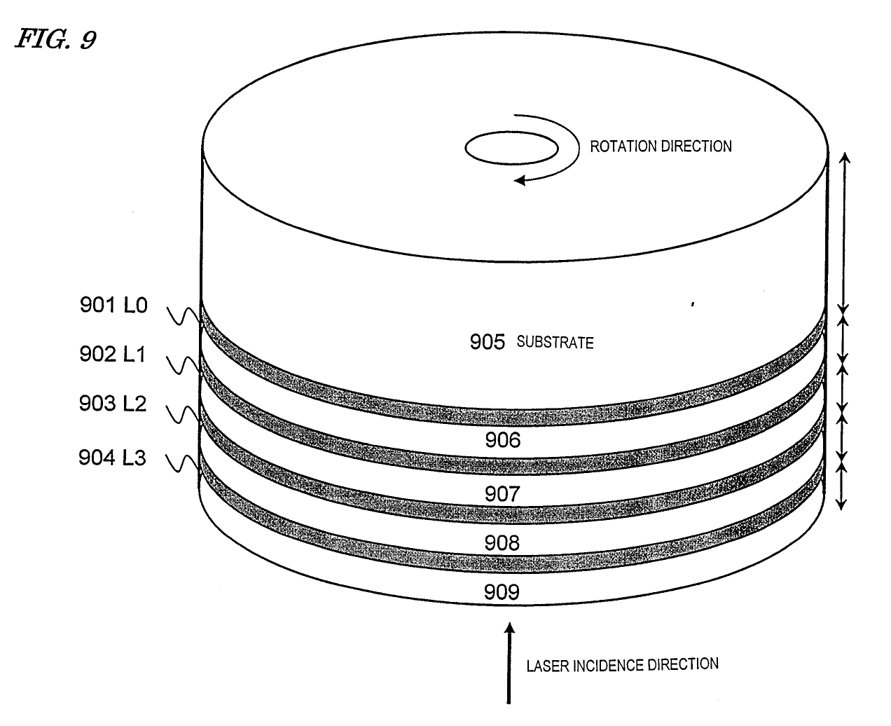

Now, FIG. 9 is a schematic view of a stacking structure of four-layer optical disc medium. Hereinafter, in the embodiments, the layers are numbered from the 0th information recording layer, instead of the first information recording layer, for the sake of convenience, i.e., in order to match the number (#) of each information recording layer and the abbreviated name thereof. Reference numeral 90 is a substrate, reference numeral 901 is a zeroth information recording layer L0 (abbreviation of Layer0), reference numeral 902 is a first information recording layer L1, reference numeral 903 is a second information recording layer L2, and reference numeral 904 is a third information recording layer L3. Reference numeral 909 is a cover layer, and the laser beam is incident from the cover layer side. The substrate 905 has a thickness of about 1.1 mm, and the cover layer 909 has a thickness of at least 40 μm. The information faces are separated from each other by transparent space layers 906, 907 and 908. Specifically in this embodiment, the cover layer 909 has a thickness of 53 μm, a space layer between L3 and L2 has a thickness of 12 μm, a space layer between L2 and L1 has a thickness of 20 μm, and a space layer between L1 and L0 has a thickness of 15 μm. It is desirable that the gaps between the information recording layers separated by the space layers are designed so as to minimize the interference of diffracting light from the information recording layers (interlayer interference), and the gaps are not limited to the interlayer distances provided by the above-mentioned thicknesses of the space layers.

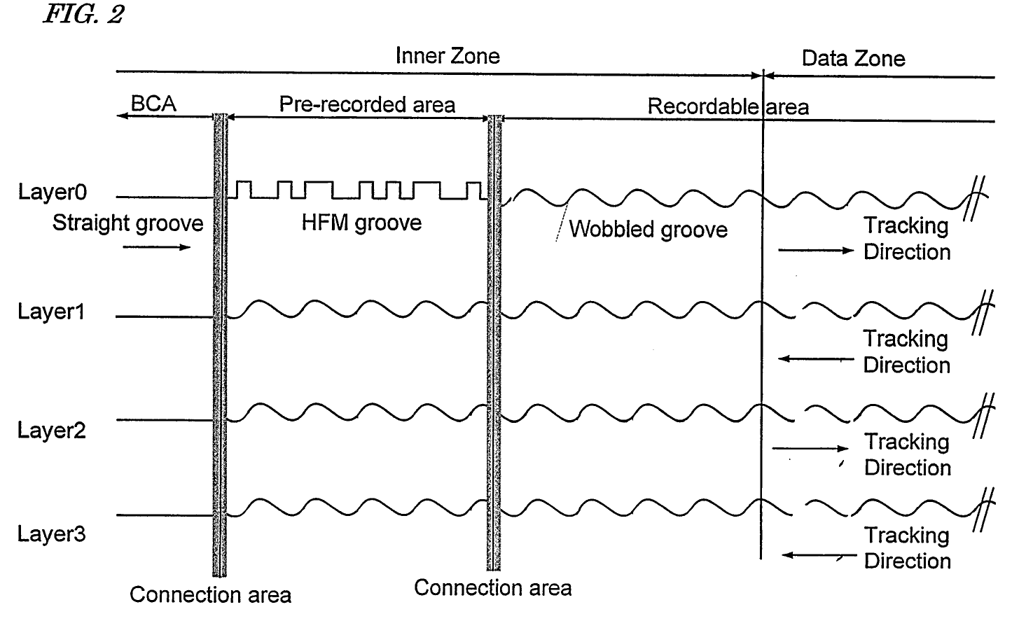

Now, FIG. 2 is a cross-sectional view of a track layout of each layer of the four-layer optical disc medium according to the present invention. As shown in FIG. 2, on the zeroth information recording layer of the four-layer optical disc medium, a unique ID for the individual medium referred to as BCA is pre-recorded by, for example, burning the information face. By concentrically arranging recording marks, bar code-like recording data is formed. BCA is formed only on L0.

An area next to BCA is a PIC area. The PIC area is referred to as a “disc management information” area or a “DI” (Disc Information) area. The disc management information includes version number, layer number, maximum recording speed, disc type such as write-once type, rewritable type or the like, recommended recording power for each information recording layer, various parameters required for OPC, recording pulse conditions, write strategy, information used for copy protection, and the like. In the PIC area, the disc management information is recorded by wobbling a guide groove formed spirally. Such pre-recorded information is non-rewritable, reproduction-only information which is pre-recorded at the time of production of the disc by a disc manufacturer. Namely, BCA and the PIC area are reproduction-only areas.

In an area next to the PIC area, an OPC area usable by the optical disc apparatus for performing test recording to obtain a recording power, recording pulse conditions or the like, and a disc management area (DMA), are provided. The OPC area is a test recording area usable for test recording performed to calibrate a change of the recording power or the recording pulse conditions when the disc is inserted into the optical disc apparatus or when a temperature change equal to or greater than a certain level occurs during the operation. The DMA (Disc Management Area) is an area usable for managing the disc management information or defect information.

An area having a radius of 24.0 mm to 58.0 mm is a data zone. The data zone is used for actually recording data desired by the user. In the data zone, an ISA (Inner Space Area) and an OSA (Outer Space Area) are set as exchangeable areas before and after a data area used for recording or reproduction of the user data. When, for example, the optical disc is used for a personal computer, a part of the data zone may become unrecordable or unreproduceable by a defect or the like. In such a case, the unrecordable or unreproduceable part (sector, cluster) is exchanged by such an exchangeable area. In real-time recording which needs a high transfer rate, such as video recording or reproduction, etc., such an exchangeable area may not be set occasionally. An area outer to the area having a radius of 58.0 mm is used as an outer zone. The outer zone includes an OPC area and a disc management area (DMA) substantially the same as those in the inner zone. The outer zone is also used as a buffer area for accommodating an overrun during a seek operation.

In the first through third information recording layers (L1 through L3), an area corresponding to BCA is provided but the unique ID is not recorded. The reason is that even if BCA information including the unique ID is newly recorded in the first through third information recording layers (L1 through L3), reliable recording may not be possibly performed. In other words, the reliability of the BCA in L0 is improved by not recording BCA in the layers other than L0.

In the four-layer optical disc medium according to the present invention, the reproduction-only PIC area having the disc management information or the like recorded at the time of production of the disc is located in the zeroth information face (L0). The PIC area is located only in L0. Thus, the optical disc apparatus can collectively read the disc management information on all the information faces of L0 through L3 and can shorten the starting time.

In the zeroth information recording layer L0 and the second information recording layer L2, addresses are recorded in the direction from the inner periphery to the outer periphery, and data is recorded or reproduced from the inner periphery to the outer periphery along the order of the addresses.

In the first information recording layer L1 and the third information recording layer L3, addresses are recorded in the direction from the outer periphery to the inner periphery, and data is recorded or reproduced from the outer periphery to the inner periphery.

Since recording or reproduction is performed in this manner in the data zone, a full seek from the outer periphery to the inner periphery is not necessary. Recording or reproduction can be performed sequentially from the layer farthest from the light incidence side toward the layer closest to the light incidence side, in the order of: the inner periphery to the outer periphery of the zeroth information recording face (L0), then the outer periphery to the inner periphery of the first information recording face (L1), et seq. In this manner, real-time recording with a high transfer rate, such as video recording or reproduction, etc. can be performed for a long time.

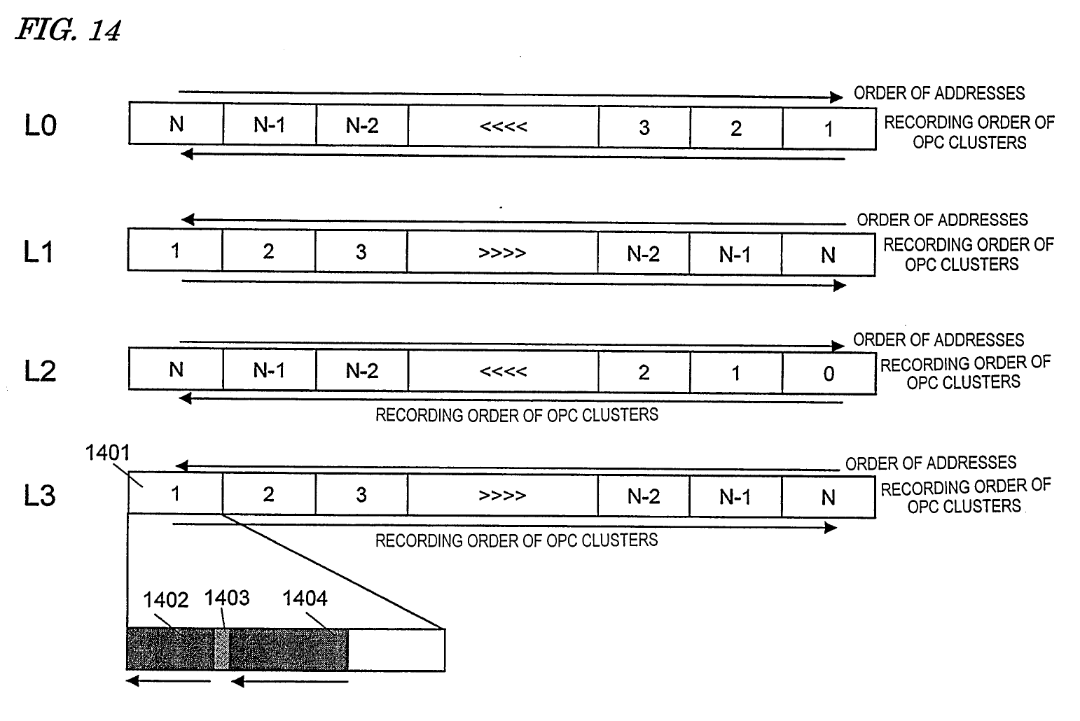

FIG. 14 shows the directions in which the clusters in the OPC area are used. The clusters in the OPC area are used in the opposite direction from in the data zone. In L0 and L2, the clusters are used from the outer periphery to the inner periphery; whereas in L1 and L3, the clusters are used from the inner periphery to the outer periphery. For example, when OPC is performed with a cluster 1401 in L3, recording is performed in an area 1402 in the cluster 1401 by the first OPC, and then a marker is recorded in an area 1403. Then, recording is performed in an area 1404 in the direction shown here by the second OPC.

### Embodiment 1

Hereinafter, a physical format, especially, positional arrangement of OPC areas, of a multilayer optical disc according to Embodiment 1 of the present invention will be described with reference to the drawings.

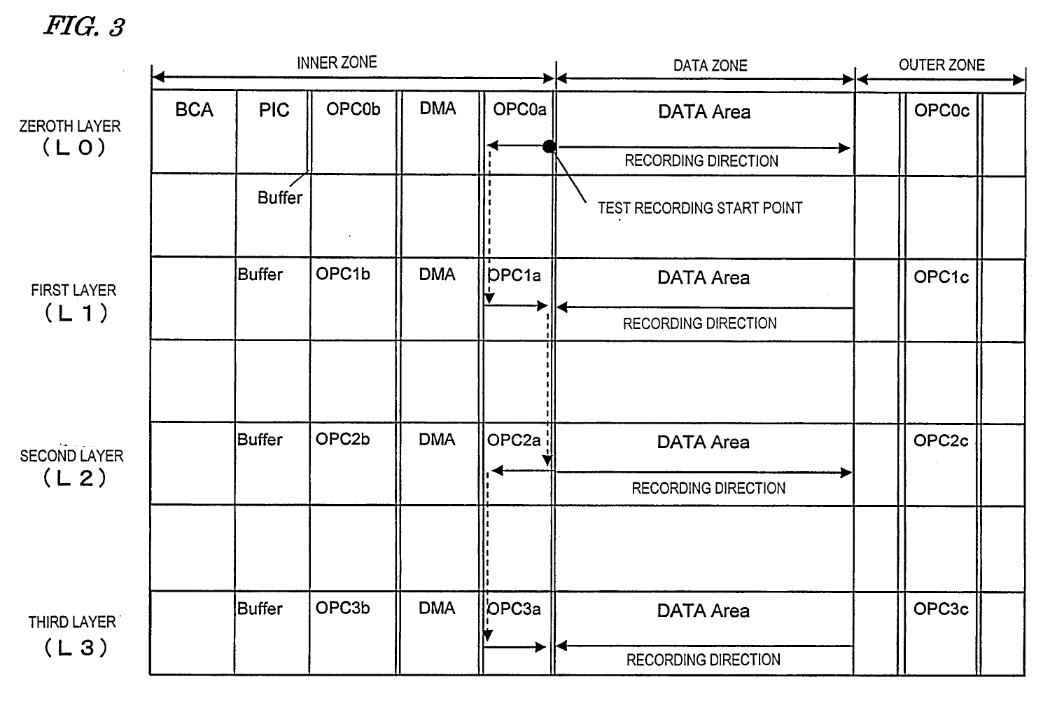

FIG. 3 shows an example of a physical format of OPC areas in each information recording layer according to Embodiment 1 of the present invention. FIG. 3 shows an example of a physical format, especially, positional arrangement of the OPC areas of the optical disc medium including four information recording layers. The zeroth information recording layer (L0) is located farthest from the laser beam incidence side, and the first information recording layer (L1) is located closer, than the zeroth information recording layer, to the laser beam incidence side. The second information recording layer (L2) and the third information recording layer (L3) are sequentially located from the side of the first information recording layer toward the laser beam incidence side. These information recording layers include an inner zone, a data zone and an outer zone from the inner periphery side to the outer periphery side along the radial direction.

In the inner zone of the zeroth information recording layer, a BCA (Burst Cutting Area) and a PIC area (management data area) are provided from the inner periphery thereof. The BCA and the PIC area are reproduction-only areas which are formed at the time of production of the disc, and disc management information (control information) or the like is described therein. The BCA and the PIC area are the reproduction-only areas, and an area outer to the PIC area is a recordable area. Outer to the PIC area, a second test recording area (OPC0-B area) usable for test recording to obtain data recording and/or reproduction conditions, a DMA in which OPC area management information or the like is recorded, and a first test recording area (OPC0-A area) are located. Adjacent to the test recording areas (OPC areas), protection areas called buffer areas (not shown) in which no data is recorded are provided.

The inner zone of each of the first through third information recording layers includes buffer areas, a second test recording area (OPC-B area), a DMA and a first test recording area (OPC-A). Adjacent to the test recording areas (OPC areas), protection areas called buffer areas (not shown) in which no data is recorded are provided.

The second test recording areas (OPC-B areas) in the zeroth through third information recording layers, i.e., OPC0b, OPC1b, OPC2b and OPC3b, are located at generally the same radial position. The expression “generally the same” is used because when the information recording layers are stacked during the production of the disc, it is not possible to align the areas of the layers with no radial positional error (±0 μm). The expression “generally the same” indicates that the areas are located at the same radial position with a potential error of approximately a pre-defined eccentric amount. Similarly, the first test recording areas (OPC-A areas) in the zeroth through third information recording layers, i.e., OPC0a, OPC1a, OPC2a and OPC3a, are located at generally the same radial position.

Outer to the inner zone, the data zone is provided. User data is recordable in a data area in the data zone.

Outer to the data zone, the outer zone is located. The outer zones in the zeroth through third information recording layers include third test recording areas (OPCC area), i.e., OPC0c, OPC1c, OPC2c and OPC3c, respectively. The third test recording areas (OPC-C areas) in the zeroth through third information recording layers, i.e., OPC0c, OPC1c, OPC2c and OPC3c, are located at generally the same radial position.

As shown in FIG. 3, by locating the first test recording areas, the second test recording areas and the third test recording areas at generally the same radial position among the information recording layers, the limited inner zone and outer zone can be effectively used to improve the space efficiency. Even when the number of information recording layers is increased to eight or 16, instead of 4 as in this embodiment, the test recording areas can be provided with certainty without increasing the physical size of the inner zone. Namely, the test recording areas can be provided with certainty without suppressing the recording capacity of the data zone. In addition, as compared with the case where the test recording areas are located so as not to be overlapped with one another, the physical size of each OPC area can be increased in the limited inner zone or outer zone. Therefore, highly reliable recording power adjustment and write strategy adjustment are realized without decreasing the number of times of the test recording. Especially for an optical disc on which recording can be done only once, for example, a write-once optical disc, such a situation can be avoided that the OPC areas are used up despite the user data zone is not full. Thus, the possibility that the recording cannot be performed on the optical disc merely because test recording cannot be performed is decreased.

Now, how to categorize the first and second OPC areas will be described. First, how to use the first recording area (OPC-A area) will be described.

The first recording area (OPC-A area) is used with no limitation on the recording power for test recording. After the optical disc is loaded and parameters required for OPC are read from the PIC area, the first OPC is performed in the first test recording area. Until the OPC is performed and the optimal recording power is found, there is no guarantee that light is emitted from the laser at an accurate power level, due to the individual variance of the optical disc apparatus or the time-wise change. Or, due to the individual variance of the optical disc, the recording power may be deviated from the power predetermined at the time of production of the disc. It is possible to perform test recording as follows: test recording is performed once with a combination of a certain optical disc apparatus and a certain optical disc medium, and the optimal recording power found with such a combination is recorded on a memory of the optical disc apparatus or in a prescribed area of the optical disc medium; and the next time test recording is performed, this recording power is used. However, at the time of next test recording, light may not be accurately emitted at the proper recording power which is to be used, due to various reasons such as dust or dirt adhering to components of an optical system of the optical pickup, fingerprints adhering to the disc, a change of the temperature of the air which changes the laser characteristics, and the like.

In summary, in an OPC area, test recording in the process of recording power learning may possibly be performed at a higher recording power than the recording power optimal for recording data. Even if test recording is performed using the history of past test recording performed with the same apparatus and the same medium, it is still possible that test recording is performed at a higher recording power than the optimal recording power because of elapse of time since the previous test recording. If test recording is performed in an OPC area in a layer close to the light incidence side at an excessively high recording power, it is conceivable that laser beam is influenced when passing through such a layer and, for example, the intensity thereof is changed, and as a result, the optimal recording power cannot be derived by OPC in an information recording layer farther from the laser beam incidence side. Specifically, the recording power may be deviated from the optimal recording power, an error may occur in reading a reproduction signal, or a tracking error signal or a focusing error signal may be distorted to make the tracking servo or focusing servo unstable.

Because of various possibilities as described above, the OPC-A areas are used sequentially from an information recording layer farthest from the light incidence side to an information recording layer closest to the light incidence side. In addition, the OPC-A areas of the information recording layers are overlapped with one another. Therefore, even if test recording is performed on an information recording layer at an excessively recording power, this does not influence the reproduction signal quality of an information recording layer farther from the laser beam incidence side, for the following reason. On any information recording layer farther from the laser beam incidence side, test recording has already been performed. In the case of an information recording layer farthest from the light incidence side, there is no information recording layer still farther from the laser beam incidence side.

Now, how to use the second test recording area (OPC-B area) will be described. The OPC-B area is mainly used for write strategy adjustment, i.e., for finding conditions such as the generation timing and length of a recording pulse stream, using the optimal recording power determined in the OPC-A area. For the information recording layer for which the optimal value of the recording power has been found with the test recording performed in the OPC-A area, there is no possibility that recording in the OPC-B area is performed at an excessively high recording power deviated from the optimal recording power.

There is a limitation on the recording power for the OPC-B area. Test recording in the OPC-B area is performed at the optimal recording power found in the OPC-A area of the same information recording layer. In the case where test recording was performed in the OPC-A area of a different information recording layer, an upper limit on the recording power usable for test recording in the OPC-B area is set based on the optimal recording power found in the OPC-A area.

The upper limit is determined based on a calculation value which is obtained by calculating the ratio between the optimal recording power determined in the OPC-A area and a recommended recording power predetermined at the time of production of the disc and pre-recorded in the management data area. Where the ratio between the optimal recording power and the recommended recording power is within a certain value range, the upper limit on the recording power usable for test recording in the OPC-B area is set based on the ratio. How to specifically find the upper limit will be described in detail in a later embodiment.

The features of the two different test recording areas (OPC-A area and OPC-B area) can be summarized as in Table 1. A test recording area is categorized as an area in which no upper limit is set on the recording power for test recording (OPC-A area) or as an area in which an upper limit is set on the recording power for test recording (OPC-B area). A test recording area in which test recording needs to be performed at a recording power equal to or lower than the determined upper limit is the OPC-B area, and a test recording area in which test recording may be performed with no upper limit on the recording power is the OPC-A area.

The order of recording is determined among the OPC areas of different categories. When test recording is performed for the first time after the multilayer optical disc medium is inserted into the optical disc apparatus, or when it is determined that there is a high possibility of writing being conducted at an excessively high power, first test recording is performed in the OPC-A area, and after the recording power is calibrated, the second or later test recording is performed in the OPC-B area of any information recording layer.

The recording order of layer is determined among the OPC-A areas of the same category but not among the OPC-B areas of the same category. As shown in FIG. 3, the recording in the OPC-A area is sequentially performed from the test recording start point of the zeroth information recording layer (L0) farthest from the light incidence side. After the OPC-A area of L0 is used up, test recording is performed in the OPC-A area of L1 closer to the light incidence side by one layer. After the OPC-A area of L1 is used up, test recording is performed in the OPC-A area of L2. In this manner, recording is performed from an information recording layer farthest from the laser beam incidence side toward an information recording layer closest to the laser beam incidence side.

The recording order of layer is not determined among the OPC-B areas. Test recording can be performed when necessary in the OPC-B area of any information recording layer.

The OPC-A areas are located in the information recording layers L1 through L3 in addition to the information recording layer L0. Therefore, even when the OPC-A area of L0 is used up, the OPC-A areas of L1 through L3 can be used sequentially. For a write-once optical disc, such a situation can be avoided that the OPC areas are used up although the user data zone is not full. Thus, the problem that, for example, the recording cannot be performed on the optical disc merely because test recording cannot be performed can be solved.

TABLE 1

| | | Limitation on | Limitation on |
|---|---|---|---|
| | | recording order of | recording order of |
| | | layer among OPC | layer among OPC |
| | Upper limit on | areas of different | areas of the same |
| | recording power | categories | category |
| OPC-A area | No | Yes (inevitable for | YES (sequentially |
| | | first recording; | from the farthest |
| | | possible for second | layer from light |
| | | recording or later) | incidence side) |
| OPC-B area | YES (equal to | YES (second test | NO (recordable |
| | or lower than | recording or later) | randomly) |
| | upper limit) | | |

### Embodiment 2

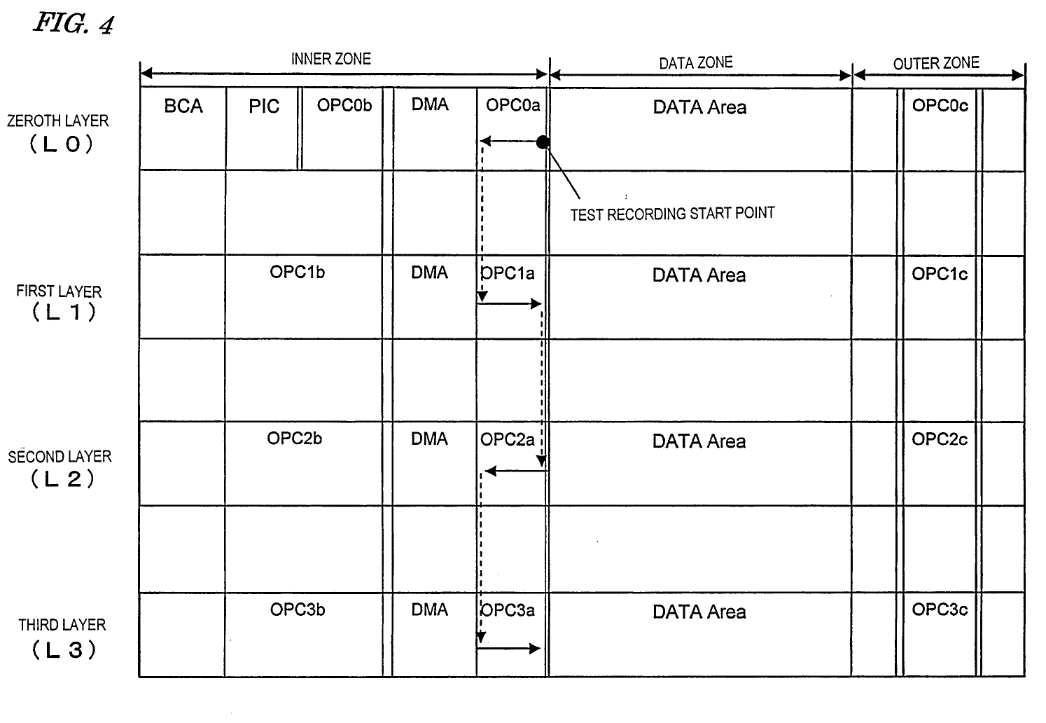

FIG. 4 shows an example of a physical format of OPC areas in each information recording layer according to Embodiment 2 of the present invention. Unlike the multilayer optical disc in Embodiment 1, as shown in FIG. 4, the OPC-B area of each of L1 through L3 is partially located overlapped with the PIC area of the zeroth information recording layer, and the physical size of the OPC-B area is larger than the physical size of the OPC-A area in the same information recording layer, respectively.

Since an upper limit is set for the recording power in the OPC-B area, recording is not performed in the OPC-B area at an excessively high recording power. Therefore, when reproducing data from the PIC area of L0, the light beam passing through the OPC-B areas of L1 through L3 is scattered or diffracted and thus can suppress the decline of the quality of the PIC area reproduction signal.

By arranging the physical format of the test recording areas in a devised manner as described above, the OPC areas can be located in the information recording layers closer to the light incidence side than the information recording layer including the PIC area. Therefore, the physical size of the test recording areas of each layer can be increased in the limited physical size of the inner zone. Thus, the inner zone can be efficiently used.

The OPC-A areas are located in the information recording layers L1 through L3 in addition to the information recording layer L0. Therefore, even when the OPC-A area of L0 is used up, the OPC-A areas of L1 through L3 can be used sequentially. For a write-once optical disc, such a situation can be avoided that the OPC areas are used up although the user data zone is not full. Thus, the problem that, for example, the recording cannot be performed on the optical disc merely because test recording cannot be performed can be solved.

Since the size of the OPC-B areas is increased, the number of times of the test recording for write strategy adjustment, which is mainly performed in the OPC-B areas, can be increased. Especially for performing high linear density recording with a recording mark or space shorter than the optical spot in a 33.4 GB or 32 GB disc, it is necessary to increase the number of times of the write strategy learning to perform the write strategy adjustment more accurately. In the case where the physical size of the OPC-B area is larger than the physical size of the OPC-A area in the same information recording layer respectively as in this embodiment, highly reliable recording power adjustment and write strategy adjustment are realized without decreasing the number of times of the test recording.

### Embodiment 3

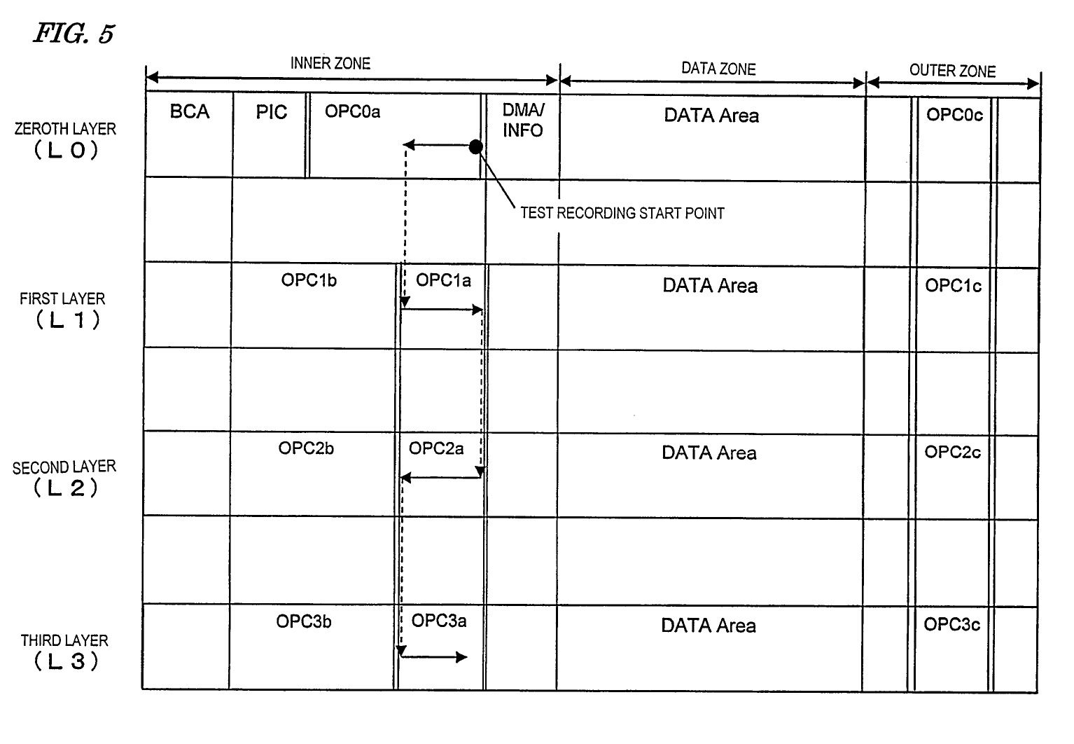

FIG. 5 shows an example of a physical format of OPC areas in each information recording layer according to Embodiment 3 of the present invention. As shown in FIG. 5, L0 includes only one test recording area (OPC-A area), whereas L1 through L3 each include two test recording areas, i.e., the OPC-A area and the OPC-B area. The OPC-B area of each of L1 through L3 is partially overlapped with the PIC area of L0. Since an upper limit is set for the recording power in the OPC-B area, recording is not performed in the OPC-B area at an excessively high recording power. Therefore, when reproducing data from the PIC area of L0, the light beam passing through the OPC-B areas of L1 through L3 is scattered or diffracted and thus can suppress the decline of the quality of the PIC area reproduction signal. The OPC-A areas of L1 through L3 are located at generally the same radial position in an overlapped manner with one another. The physical size of the OPC-A area of L0 is larger than the physical size of the OPC-A area in each of L1 through L3.

By arranging the physical format of the test recording areas in a devised manner as described above, the OPC areas can be located in the information recording layers closer to the light incidence side than the information recording layer including the PIC area. Therefore, the physical size of the test recording area(s) of each layer can be increased in the limited physical size of the inner zone. Thus, the inner zone can be efficiently used.

Since the test recording area of L0 is entirely the OPC-A area, the buffer areas adjacent to the OPC area can be decreased as compared with the case where two test recording areas of the OPC-A area and the OPC-B area are provided. Thus, the inner zone can be more efficiently used.

Since a part of the OPC-A area of L0 and the OPC-A areas of the L1 through L3 are located at generally the same radial position with an arrangement as shown in FIG. 5, it is not necessary to provide a buffer area at the radial position of L0 corresponding to the side of the OPC-A areas of L1 through L3. Thus, the inner zone can be still more efficiently used.

The physical size of the OPC-A area of L0 is larger than the physical size of the OPC-A area in each of L1 through L3. Therefore, even if the optical disc is inserted into the optical disc apparatus and started a great number of times, the probability that the OPC-A area of L0 is used up can be decreased. It is made possible to often perform the learning at the time of start in L0, which shortens the starting time.

The OPC-A areas are located in the information recording layers L1 through L3 in addition to the information recording layer L0. Therefore, even when the OPC-A area of L0 is used up, the OPC-A areas of L1 through L3 can be used sequentially. For a write-once optical disc, such a situation can be avoided that the OPC areas are used up although the user data zone is not full. Thus, the problem that, for example, the recording cannot be performed on the optical disc merely because test recording cannot be performed can be solved.

### Embodiment 4

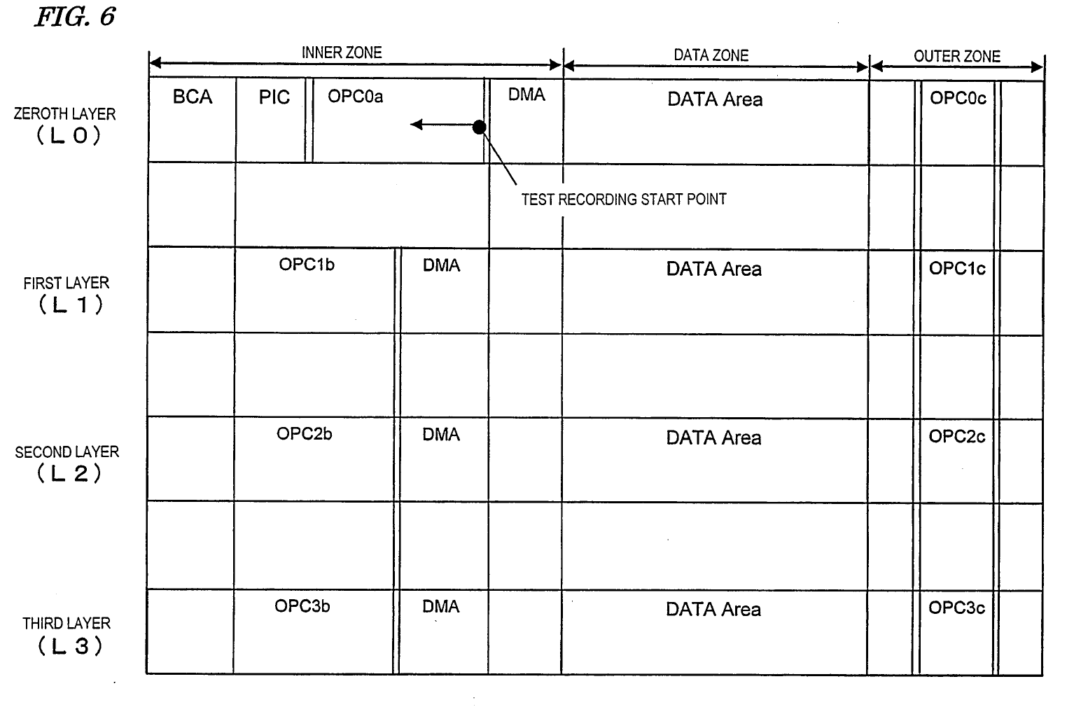

FIG. 6 shows an example of a physical format of OPC areas in each information recording layer according to Embodiment 4 of the present invention. In FIG. 6, L0 includes only one test recording area (OPC-A area), whereas L1 through L3 each include one recording area, i.e., the OPC-B area. The OPC-B area of each of L1 through L3 is partially overlapped with the PIC area of L0. Since an upper limit is set for the recording power in the OPC-B area, recording is not performed in the OPC-B area at an excessively high recording power. Therefore, when reproducing data from the PIC area of L0, the light beam passing through the OPC-B areas of L1 through L3 is scattered or diffracted and thus can suppress the decline of the quality of the PIC area reproduction signal. The OPC-B areas of L1 through L3 are located at generally the same radial position in an overlapped manner with one another.

By arranging the physical format of the test recording areas in a devised manner as described above, the OPC areas can be located in the information recording layers closer to the light incidence side than the information recording layer of the PIC area. Therefore, the physical size of the test recording area of each layer can be increased in the limited physical size of the inner zone. Thus, the inner zone can be efficiently used.

Since the test recording area of L0 is entirely the OPC-A area, the buffer areas adjacent to the OPC area can be decreased as compared with the case where two test recording areas of the OPC-A area and the OPC-B area are provided. Thus, the inner zone can be more efficiently used.

Since a part of the OPC-A area of L0 and the OPC-A areas of the L1 through L3 are located at generally the same radial position with an arrangement as shown in FIG. 6, it is not necessary to provide a buffer area at the radial position of L0 corresponding to the side of the OPC-A area of each of L1 through L3. Thus, the inner zone can be still efficiently used.

### Embodiment 5

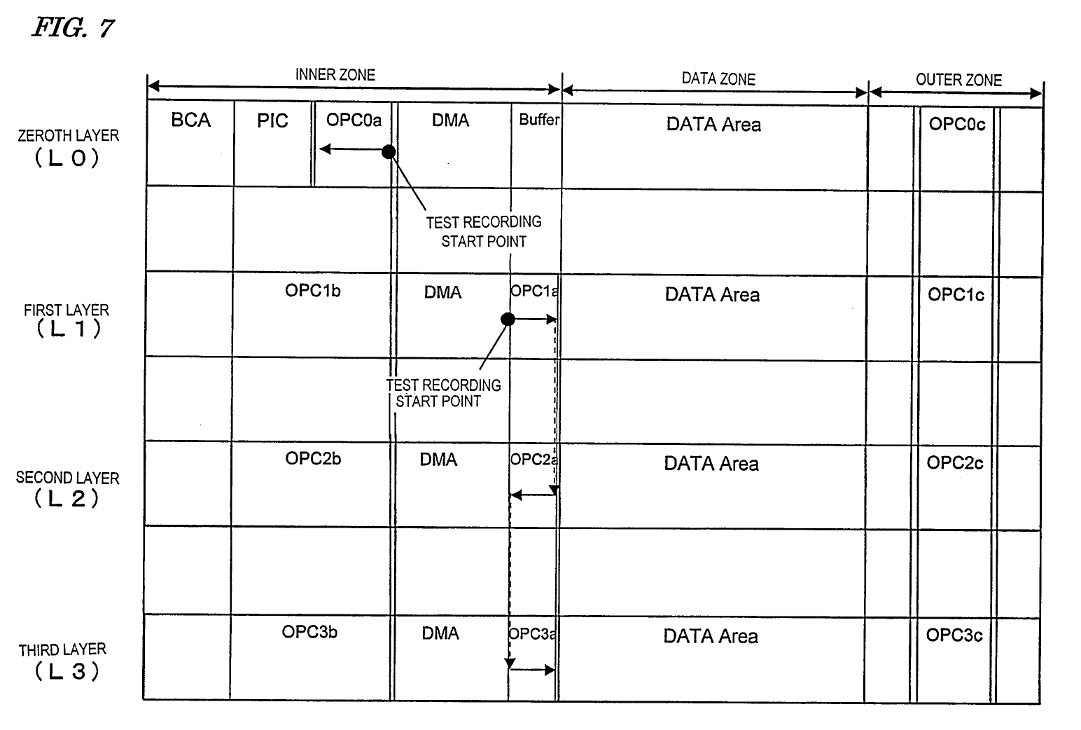

FIG. 7 shows an example of a physical format of OPC areas in each information recording layer according to Embodiment 5 of the present invention. In FIG. 7, L0 includes only one test recording area (OPC-A area), whereas L1 through L3 each include two test recording areas, i.e., the OPC-A area and the OPC-B area. The OPC-B area of each of L1 through L3 is partially overlapped with the PIC area of L0. Since an upper limit is set for the recording power in the OPC-B area, recording is not performed in the OPC-B area at an excessively high recording power. Therefore, when reproducing data from the PIC area of L0, the light beam passing through the OPC-B areas of L1 through L3 is scattered or diffracted and thus can suppress the decline of the quality of the PIC area reproduction signal. The OPC-B areas of L1 through L3 are located at generally the same radial position in an overlapped manner with one another. The OPC-A areas of L1 through L3 are located at generally the same radial position in an overlapped manner with one another.

In this case, test recording can be started using the OPC-A area of each of the two information recording layers L0 and L1. For designing the recording film, the information recording layers L1 through L3 are restricted to be semi-transparent so that light is transmitted to the information recording layer(s) farther from the light incidence side than L1 through L3 respectively, but there is no such restriction on the information recording layer L0. Namely, the recording material and the structure of the recording film are significantly different between L0 and L1 through L3. Because the recording films of L0 and L1 through L3 have different properties, it is recommended to first perform test recording both in the OPC-A area of L0 and the OPC-A area of L1, so that an upper limit on the recording power for test recording in L2 and L3 is found based on the optimal recording power found in L1. Where the recording films of L2 and L3 have substantially the same properties as the recording film of L1, the optimal recording powers for L2 and L3 can be found more precisely in this manner.

The OPC-A areas are located in the information recording layers L1 through L3 in addition to the information recording layer L0. Therefore, even when the OPC-A area of L0 is used up, the OPC-A areas of L1 through L3 can be used sequentially. For a write-once optical disc, such a situation can be avoided that the OPC areas are used up although the user data zone is not full. Thus, the problem that, for example, the recording cannot be performed on the optical disc merely because test recording cannot be performed can be solved.

### Embodiment 6

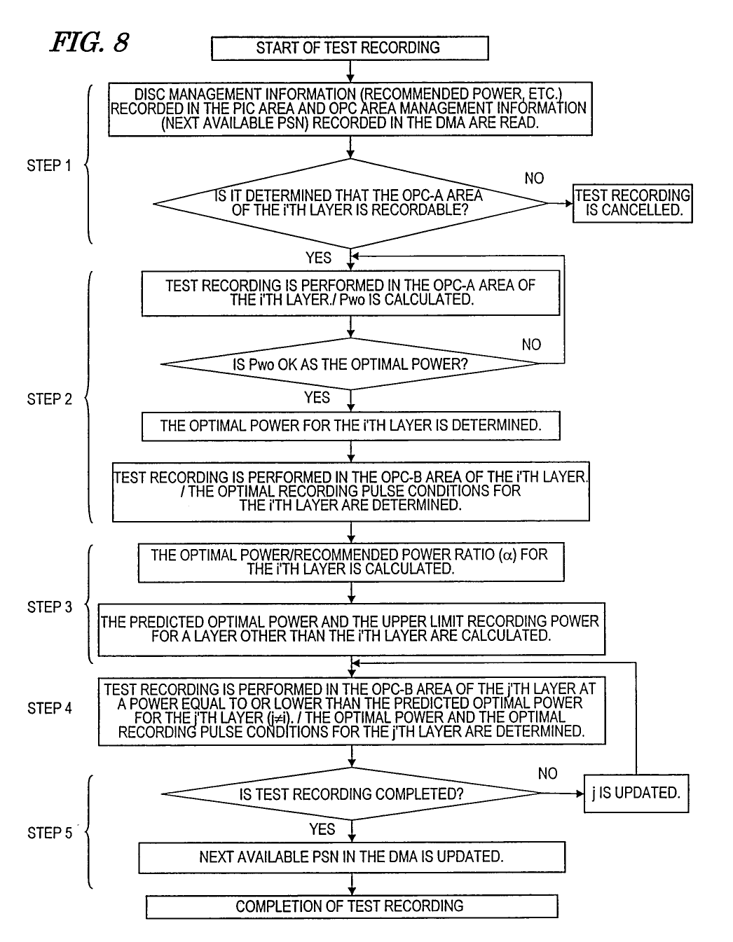

Now, a recording method for a multilayer optical information recording medium according to the present invention will be described with reference to the drawings. A procedure of test recording according to Embodiment 6 of the present invention will be described with reference to FIG. 8. Any of the multilayer optical disc mediums used in Embodiments 1 through 4 is usable.

In a first step, the disc management information recorded in the PIC area and the OPC management information recorded in the DMA are read. What is to be read includes the recommended recording power for each information recording layer, various parameters required for OPC and the write strategy parameter, which are pre-recorded in the PIC area; and the positions of the OPC areas in each information recording layer, for example, information indicating the recording start addresses and/or recording end addresses, and Next Available PSN (Physical Sector Number), which are recorded in the DMA. The Next Available PSN is information indicating the currently usable position in each OPC area. When the optical disc is loaded on an optical recording/reproduction apparatus, the OPC area management information in the DMA is read. From the information, the positions of the OPC areas in the optical disc and the positions of the usable OPC areas are found, so that OPC can be performed in the OPC areas thus found. When it is determined from the read information that the OPC-A area of an i'th information recording layer (i is an integer of 0 through 3) is recordable, the procedure advances to the next step. When all the OPC-A areas are used up, it is determined that test recording is not possible and is cancelled.

In a second step, test recording is performed in the OPC-A area of the i'th information recording layer to find an optimal value of the recording power. Test recording is performed at a plurality of recording powers using the OPC parameters read from the PIC area, and the modulation signal degree characteristics of the recorded signals are measured. Based on the measurement results, a prescribed calculation is performed to find the optimal recording power. How to find the optimal recording power from the measurement results of the modulation signal degree will be described in a later embodiment.

Next, it is checked whether the optimal recording power found in the OPC-A area is the proper optimal recording power which is to be found. The optimal recording power (Pwoi) found in the OPC-A area in the above-described operation procedure of finding the optimal recording power is compared with the recommended recording power (Pwpi) read from the disc management information pre-recorded in the PIC area of the optical disc. When the optimal recording power (Pwoi) is higher than the recommended recording power (Pwpi) by, for example, more than 5% (Pwoi/Pwpi−1>5%), the found optimal recording power (Pwoi) is determined to be inappropriate and the write strategy is changed. Or, the OPC procedure described above is re-performed with the same write strategy in another attempt to find an optimal recording power (Pwoi).

There is another method for checking. In order to avoid such a situation that the optimal recording power found in the OPC-A area using the optical disc apparatus during the above-described operation procedure of finding the optimal recording power is substantially higher than the recording power assumed by the manufacturer of the optical disc at the time of production, the following is performed. The target modulation signal degree (Mmax) between the optimal recording power and the recommended recording power read from the disc management information pre-recorded in the PIC area of the optical disc is compared with the modulation signal degree (Mo) of the signal recorded with the optimal recording power. When the modulation signal degree of the signal recorded with the optimal recording power is higher than the target modulation signal degree (Mmax) (i.e., Mo>Mmax), the found optimal recording power (Pwoi) is determined to be too high and the write strategy is changed. Or, the OPC procedure described above is re-performed with the same write strategy in another attempt to find an optimal recording power (Pwoi). When it is determined as a result of the comparison that the modulation signal degree of the signal recorded with the optimal recording power (Mo) is equal to or lower than the target modulation signal degree (Mmax) (i.e., Mo≦Mmax), the found optimal recording power (Pwoi) is determined to be the optimal recording power.

Then, test recording is performed in the OPC-B area of the i'th information recording layer (when i=0, the OPC-A area is also usable) using the optimal recording power to find optimal values of the recording pulse conditions (write strategy conditions). Thus, the test recording on the i'th layer is completed.

The above examples, which are described as the methods for checking the optimal recording power, may be combined, or another preferable method may be used. For example, jitter, MLSE, β, asymmetry and the like may be combined to be used as a determination basis.

In a third step, a preparation is made for test recording on a j'th layer, which is different from the i'th layer. The ratio α (=Pwoi/Pwpi) between the optimal recording power (Pwoi) and the recommended recording power (Pwpi) for the i'th information recording layer is found, and the optimal recording power predicted for the j'th information recording layer (Pwyj) is calculated from the recommended recording power (Pwpi) for the j'th information recording layer using the following expression.

(Pwyj)=(Pwpj)×α

A value obtained by multiplying the optimal recording power predicted for the j'th information recording layer (Pwyj) by a predetermined coefficient X (for example, 1.1) is determined as the upper limit recording power for the j'th layer (Pwmaxj).

(Pwmaxj)=(Pwyj)×X

In the above, α is the ratio between the optimal recording power found by the test recording and the recommended recording power. Namely, α is an index indicating how much the absolute value of the recording power which is set by the optical disc apparatus is deviated from the recommended recording power determined by the disc manufacturer at the time of production, due to dirt, dust or any other element caused to the optical disc apparatus. When α=1, the found optimal recording power matches the recommended recording power, namely, the recording power found by performing the test recording using the optical disc apparatus matches the power pre-recorded by the disc manufacturer at the time of production. When α>1, for example, dirt, dust or the like adheres to an element of an optical system, for example, an objective lens of the optical disc apparatus, and as a result, the recording power on the optical disc face is lower than the recording power immediately after laser beam is emitted, due to a loss caused in the middle of the optical path. Or, when α>1, there may be an error in the calibration of the recording power performed by the optical disc apparatus. When α>1 is caused for such a reason, substantially the same loss of the recording power or calibration error also occurs in the other information recording layers. Therefore, the ratio α is used to correct an error between the recording power which is set by the optical disc apparatus and the actual power irradiating the information recording face of the optical disc.

In a fourth step, test recording is performed in the OPC-B area of the j'th information recording layer to find an optimal recording power and optimal recording pulse conditions for the j'th layer. Test recording is performed at a plurality of recording powers equal to or lower than the upper limit recording power (Pwmaxj) determined in the third step, and the modulation signal degree characteristics of the recorded signals are measured to find the optimal recording power for the j'th information recording layer (Pwoj). After the optimal recording power for the j'th information recording layer (Pwoj) is determined, test recording is performed in the OPC-B area of the j'th information recording layer at the optimal recording power (Pwoj) to find optimal values of the recording pulse conditions (write strategy conditions). Thus, the test recording on j'th information recording layer is completed. Although omitted here, a process of checking whether the found optimal recording power (Pwoj) is the proper optimal recording power which is to be found may be performed as in the second step.

In a fifth step, it is checked whether the test recording is completed on all the information recording layers. When the test recording is not completed on all the information recording layers, the procedure returns to the fourth step, and the test recording is performed on the remaining information recording layer(s) to find the optimal values of the recording power and the write strategy conditions. When test recording is completed on all the information recording layers, test recording completion processing is performed. Namely, the Next Available PSN information in the DMA is updated, and thus the test recording is finished.

In this embodiment, X=1.1 as an example, but the value of X is not limited to 1.1. The value of X may be set to X=1, in which case the recording is performed with the predicted optimal recording power as the upper limit.

When the optimal recording power found by the test recording performed in the OPC-B area exceeds the upper limit of the recording power found in the third step, the upper limit of the recording power may be updated to an appropriated value. However, before the optimal recording power is found, test recording cannot be performed with a recording power exceeding the upper limit determined previously.

This embodiment is explained as providing a description of a recording method. This is merely because the procedure of recording operation is mainly described. Substantially the same procedure is usable for reproduction as well as for recording, and this embodiment can be interpreted as describing an optical recording/reproduction method.

### Embodiment 7

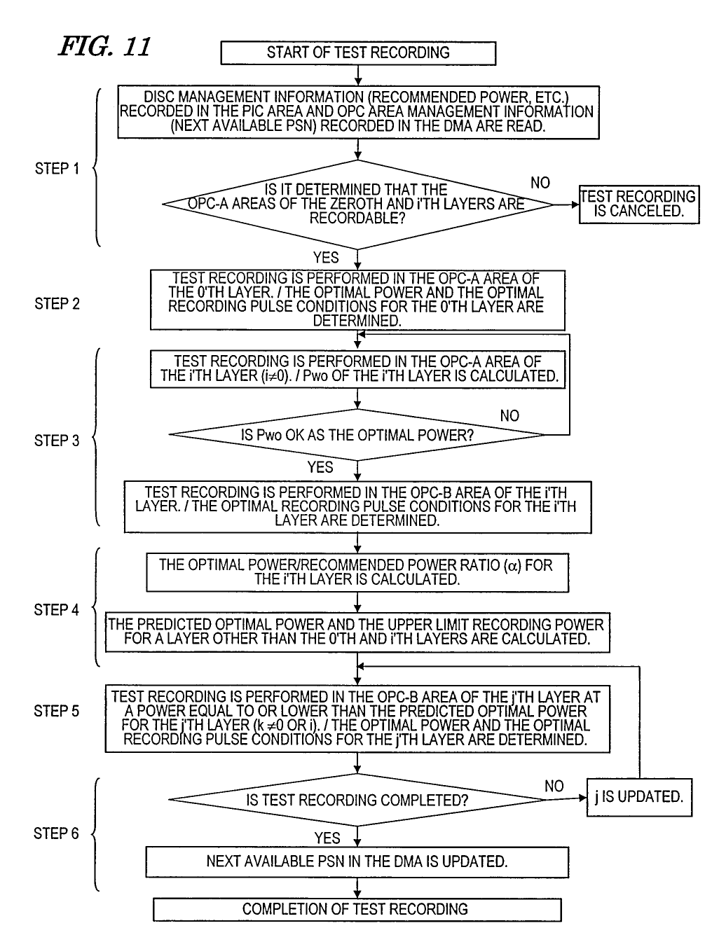

Now, a recording method for a multilayer optical information recording medium according to the present invention will be described with reference to the drawings. A procedure of test recording according to Embodiment 7 of the present invention will be described with reference to FIG. 11. The multilayer optical disc medium used in Embodiment 5 is usable.

In a first step, the disc management information recorded in the PIC area and the OPC management information recorded in the DMA are read. What is to be read includes the recommended recording power for each information recording layer, various parameters required for OPC and the write strategy parameter, which are pre-recorded in the PIC area; and the positions of the OPC areas in each information recording layer, for example, information indicating the recording start addresses and/or recording end addresses, and Next Available PSN (Physical Sector Number), which are recorded in the DMA. The Next Available PSN is information indicating the currently usable position in each OPC area. When the optical disc is loaded on an optical recording/reproduction apparatus, the OPC area management information in the DMA is read. From the information, the positions of the OPC areas in the optical disc and the positions of the usable OPC areas are found, so that OPC can be performed in the OPC areas thus found. When it is determined from the read information that the OPC-A area of the zeroth information recording layer and the OPC-A area of the i'th information recording layer are recordable, the procedure advances to the next step. When the OPC-A area of the zeroth information recording layer is used up, or when all the OPC-A areas are used up, it is determined that test recording is not possible and is cancelled. When the OPC-A area of the zeroth information recording layer is recordable and the OPC-A areas of the first through third information recording layers are used up, test recording is performed in the procedure described in Embodiment 6.

In a second step, test recording is performed in the OPC-A area of the zeroth information recording layer to find an optimal value of the recording power. Test recording is performed at a plurality of recording powers using the OPC parameters read from the PIC area, and the modulation signal degree characteristics of the recorded signals are measured. Based on the measurement results, a prescribed calculation is performed to find the optimal recording power. In addition, test recording is performed at the optimal recording power to find the optimal recording pulse conditions (write strategy conditions) for the zeroth layer. Thus, the test recording on the zeroth information recording layer is completed. How to find the optimal recording power from the measurement results of the modulation signal degree will be described in a later embodiment.

In a third step, test recording is performed in the OPC-A area of the i'th information recording layer to find an optimal value of the recording power. Test recording is performed at a plurality of recording powers using the OPC parameters read from the PIC area, and the modulation signal degree characteristics of the recorded signals are measured. Based on the measurement results, a prescribed calculation is performed to find the optimal recording power.

Next, it is checked whether the optimal recording power found in the OPC-A area is the proper optimal recording power which is to be found. The optimal recording power (Pwoi) found in the OPC-A area of the i'th information recording layer in the above-described operation procedure of finding the optimal recording power is compared with the recommended recording power (Pwpi) read from the disc management information pre-recorded in the PIC area of the optical disc. When the optimal recording power (Pwoi) is higher than the recommended recording power (Pwpi) by, for example, a level equal to or more than 5% (Pwoi/Pwpi−1≧5%), the found optimal recording power (Pwoi) is determined to be inappropriate and the write strategy is changed. Or, the OPC procedure described above is re-performed with the same write strategy in another attempt to find an optimal recording power (Pwoi).

There is another method for checking. In order to avoid such a situation that the optimal recording power found in the OPC-A area using the optical disc apparatus during the above-described operation procedure of finding the optimal recording power is substantially higher than the recording power assumed by the manufacturer of the optical disc at the time of production, the following is performed. The target modulation signal degree (Mmax) between the optimal recording power and the recommended recording power read from the disc management information pre-recorded in the PIC area of the optical disc is compared with the modulation signal degree (Mo) of the signal recorded with the optimal recording power. When the modulation signal degree of the signal recorded with the optimal recording power is higher than the target modulation signal degree (Mmax) (i.e., Mo>Mmax), the found optimal recording power (Pwoi) is determined to be too high and the write strategy is changed. Or, the OPC procedure described above is re-performed with the same write strategy in another attempt to find an optimal recording power (Pwoi). When it is determined as a result of the comparison that the modulation signal degree of the signal recorded with the optimal recording power (Mo) is equal to or lower than the target modulation signal degree (Mmax) (i.e., Mo<Mmax), the found optimal recording power (Pwoi) is determined to be the optimal recording power.

Then, test recording is performed in the OPC-B area of the i'th information recording layer using the optimal recording power to find optimal values of the recording pulse conditions (write strategy conditions) for the i'th layer. Thus, the test recording on the i'th layer is completed.

The above examples, which are described as the methods for checking the optimal recording power, may be combined, or another preferable method may be used. For example, jitter, MLSE, β, asymmetry and the like may be combined to be used as a determination basis.

In a fourth step, a preparation is made for test recording on the j'th layer, which is different from the i'th layer. The ratio α (=Pwoi/Pwpi) between the optimal recording power (Pwoi) and the recommended recording power (Pwpi) for the i'th information recording layer is found, and the optimal recording power predicted for the j'th information recording layer (Pwyj) is calculated from the recommended recording power (Pwpi) for the j'th information recording layer using the following expression.

(Pwyj)=(Pwpj)×α

A value obtained by multiplying the optimal recording power predicted for the j'th information recording layer (Pwyj) by a predetermined coefficient X (for example, 1.1) is determined as the upper limit recording power for the j'th layer (Pwmaxj).

(Pwmaxj)=(Pwyj)×X

In the above, a is the ratio between the optimal recording power found by the test recording and the recommended recording power. Namely, α is an index indicating how much the absolute value of the recording power which is set by the optical disc apparatus is deviated from the recommended recording power determined by the disc manufacturer at the time of production, due to dirt, dust or any other element caused to the optical disc apparatus. When α=1, the found optimal recording power matches the recommended recording power, namely, the recording power found by performing the test recording using the optical disc apparatus matches the power pre-recorded by the disc manufacturer at the time of production. When α>1, for example, dirt, dust or the like adheres to an element of an optical system, for example, an objective lens of the optical disc apparatus, and as a result, the recording power on the optical disc face is lower than the recording power immediately after laser beam is emitted, due to a loss caused in the middle of the optical path. Or, when α>1, there may be an error in the calibration of the recording power performed by the optical disc apparatus. When α>1 is caused for such a reason, substantially the same loss of the recording power or calibration error also occurs in the other information recording layers. Therefore, the ratio α is used to correct an error between the recording power which is set by the optical disc apparatus and the actual power irradiating the information recording face of the optical disc.

In a fifth step, test recording is performed in the OPC-B area of the j'th information recording layer to find an optimal recording power and optimal recording pulse conditions for the j'th layer. Test recording is performed at a plurality of recording powers equal to or lower than the upper limit recording power (Pwmaxj) determined in the fourth step, and the modulation signal degree characteristics of the recorded signals are measured to find the optimal recording power for the j'th information recording layer (Pwoj). After the optimal recording power for the j'th information recording layer (Pwoj) is determined, test recording is performed in the OPC-B area of the j'th information recording layer at the optimal recording power (Pwoj) to find optimal values of the recording pulse conditions (write strategy conditions). Thus, the test recording on the j'th information recording layer is completed. Although omitted here, a process of checking whether the found optimal recording power (Pwoj) is the proper optimal recording power which is to be found may be performed as in the third step.

In a sixth step, it is checked whether the test recording is completed on all the information recording layers. When the test recording is not completed on all the information recording layers, the procedure returns to the fifth step, and the test recording is performed on the remaining information recording layer(s) to find the optimal values of the recording power and the write strategy conditions. When test recording is completed on all the information recording layers, test recording completion processing is performed. Namely, the Next Available PSN information in the DMA is updated, and thus the test recording is finished.

In this embodiment, X=1.1 as an example, but the value of X is not limited to 1.1. The value of X may be set to X=1, in which case the recording is performed with the predicted optimal recording power as the upper limit.

When the optimal recording power found by the test recording performed in the OPC-B area exceeds the upper limit of the recording power found in the fourth step, the upper limit of the recording power may be updated to an appropriated value. However, until the optimal recording power is found, test recording cannot be performed with a recording power exceeding the upper limit determined before.

This embodiment is explained as providing a description of a recording method. This is merely because the procedure of recording operation is mainly described. Substantially the same procedure is usable for reproduction as well as for recording, and this embodiment can be interpreted as describing an optical recording/reproduction method.

### Embodiment 8

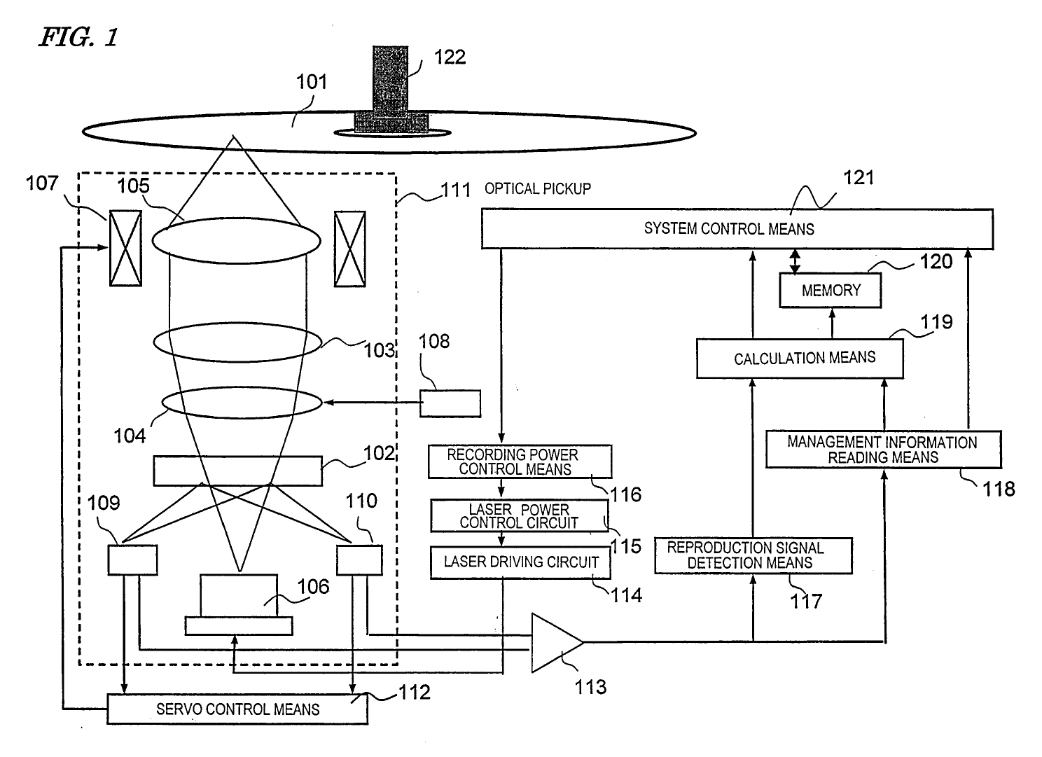

Now, a recording/reproduction apparatus for a multilayer optical information recording medium according to the present invention will be described with reference to the drawings. FIG. 1 shows an overall structure of the recording/reproduction apparatus according to Embodiment 8 of the present invention usable for a multilayer optical information recording medium. An operation of performing test recording on each information recording layer using any of the multilayer optical discs in Embodiments 1 through 5 and any of the recording methods in Embodiments 6 and 7 will be described.

FIG. 1 shows, for example, the following: a multilayer optical disc 101, which is a multilayer optical information recording medium (BD-R medium), a diffraction element 102, collimator lenses 103 and 104, an objective lens 105, a laser beam source 106, an actuator 107, spherical aberration compensation means 108, photo detectors 109 and 110, an optical pickup 111, servo control means 112 and a spindle motor 122.

A light beam emitted from the laser beam source 106 is converted into parallel light by the collimator lenses 103 and 104, is incident on the objective lens 105 and is converged on an information recording face of the multilayer optical disc 101. The light beam reflected by the multilayer optical disc 101 advances on the optical path mentioned above in the opposite direction to be collected by the collimator lenses 103 and 104 and is incident on the photo detectors 109 and 110 by beam splitting means of the diffraction element 102. A servo signal (focusing error signal and tracking error signal) and information signal (RF signal) are generated from signals output from the photo detectors 109 and 110. The servo control means 112 performs focusing control, which is positional control regarding a direction of an optical axis of the objective lens 105, and tracking control, which is positional control regarding a direction vertical to the optical axis and also vertical to the scanning direction of the light beam, thereby controlling driving means such as a coil or a magnet to control the actuator 107. An RF signal is generated by RF signal calculation means 113. The spherical aberration compensation means 108 drives the collimator lens 104 to perform optimal spherical aberration compensation in accordance with the distance of each information recording layer from the surface of the optical disc. The recording/reproduction apparatus also includes the following: a laser driving circuit 114 for driving the laser beam source 106 in the optical pickup 111, a laser power control circuit 115 for performing power control on the laser driving circuit 114 at a desired laser output, recording power control means 116 for setting a plurality of recording powers for the laser power control circuit 115 and issuing an instruction on test recording, data recording or reproduction, reproduction signal detection means 117 for detecting the signal quality (modulation signal degree, asymmetry, β, jitter, MLSE, etc.) of a reproduction signal from the RF signal, management information reading means 118 for reading, from the RF signal, the disc management information recorded in the PIC area of the multilayer optical disc 101 or OPC area management information recorded in the DMA of the multilayer optical disc 101, and calculation means 119 for calculating an optimal recording power based on the modulation signal degree characteristics detected by the reproduction signal detection means as a result of reproduction of a test-recorded signal, and also calculating the ratio between the optimal recording power (Pwoi) and the recommended recording power (Pwpi) to calculate an upper limit power for test recording. An operation of the calculation means 119 is as described above in the third step in Embodiment 6 or in the fourth step in Embodiment 7. Based on the results of the test recording, the optimal recording power or the upper limit recording power is calculated. The recording/reproduction apparatus also includes a memory 120 for storing any of, or all of, the optimal recording power for each information recording layer found by the test recording, the ratio (α) between the optimal recording power and the recommended recording power, and the upper limit recording power, and system control means 121 for setting prescribed recording conditions on the recording power control means 116 based on the calculation results of the calculation means 119 or information read by the management information reading means 118. The system control means 121 issues an instruction to the recording power control means 116 so that the test recording operation is repeated until the test recording is completed on all the information recording layers.

Now, an operation of learning an optimal recording power using the recording/reproduction apparatus for the multilayer optical information recording medium will be described in detail.

Referring to FIG. 1, the light beam emitted from the laser beam source 106 driven by the laser driving circuit 114 passes through the collimator lens 104 moved by the spherical aberration compensation means 108 and is collected to a desired information recording layer of the multilayer optical disc 101, which is a multilayer optical information recording medium (BD-R medium). An optical spot is formed on the desired information recording layer by focusing control or tracking control performed by the servo control means 112. The optical pickup 111 seeks to an inner periphery area of the multilayer optical disc 101 and reads the disc management information (DI: Disc Information) from the PIC area. The servo control means 112 allows the optical spot to seek to a test recording area of the multilayer optical disc 101 for performing focusing control or tracking control. The system control means 121 sets a plurality of recording powers within a range of ±10% around the target recording power (Pind), which is one of the OPC parameters in the DI information, and instructs the recording power control means 116 to perform test recording a plurality of times while changing the recording power. The laser output control means 115 provides power servo so that light is emitted at a desired recording power, the laser driving circuit 114 drives the laser beam source 106, and a signal is recorded on a desired track (or a desired cluster) in a desired test recording area by the light beam collected by the objective lens 105.

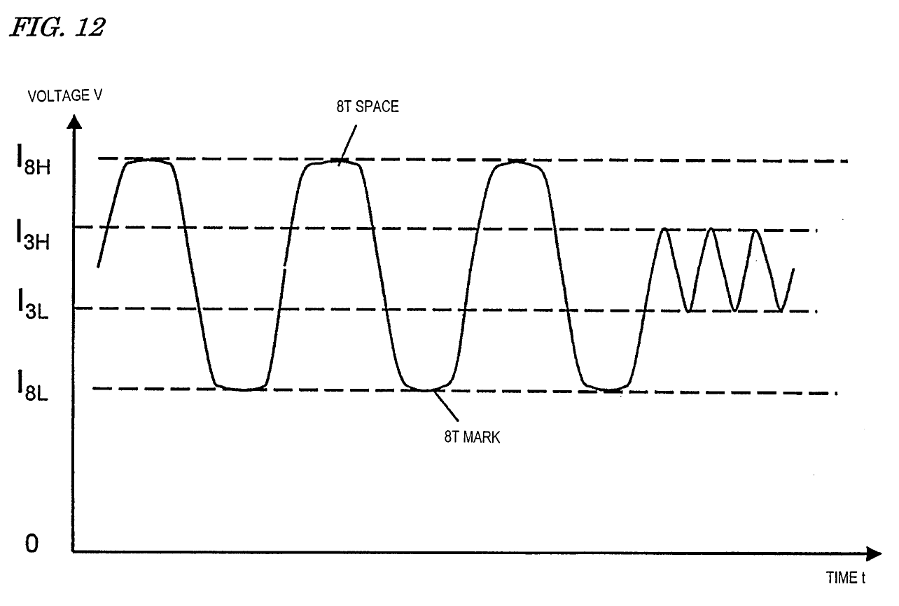

Now, a reproduction operation of a recorded signal will be described. The light reflected by the track (cluster) is received by the photo detectors 109 and 110 in the optical pickup 111 and is converted into an electric signal. Thus, an RF signal is generated by the RF signal calculation means 113. The reproduction signal detection means 117 detects the modulation signal degree with respect to the plurality of recording powers used for the test recording. With reference to FIG. 12, the modulation signal degree detected by the reproduction signal detection means 117 from the RF signal will be described. FIG. 12 shows a reproduction signal obtained from a recorded signal including a 8T signal. In an upper part of FIG. 12, the voltage level for reproducing a 8T space formed on the optical disc is shown (I8H); and in a lower part of FIG. 12, the voltage level for reproducing a 8T mark formed on the optical disc is shown (I8L). The reproduction signal detection means 117 detects the voltage level (I8H) of the 8T space, which is the longest space, and the voltage level (I8L) of the 8T mark, which is the longest mark, from the RF signal.

The calculation means 119 calculates the modulation signal degree (MOD) from the voltage levels (I8H, I8L) detected by the reproduction signal detection means 117. The modulation signal degree is calculated by the calculation of MOD=(I8H−I8L)/I8H.

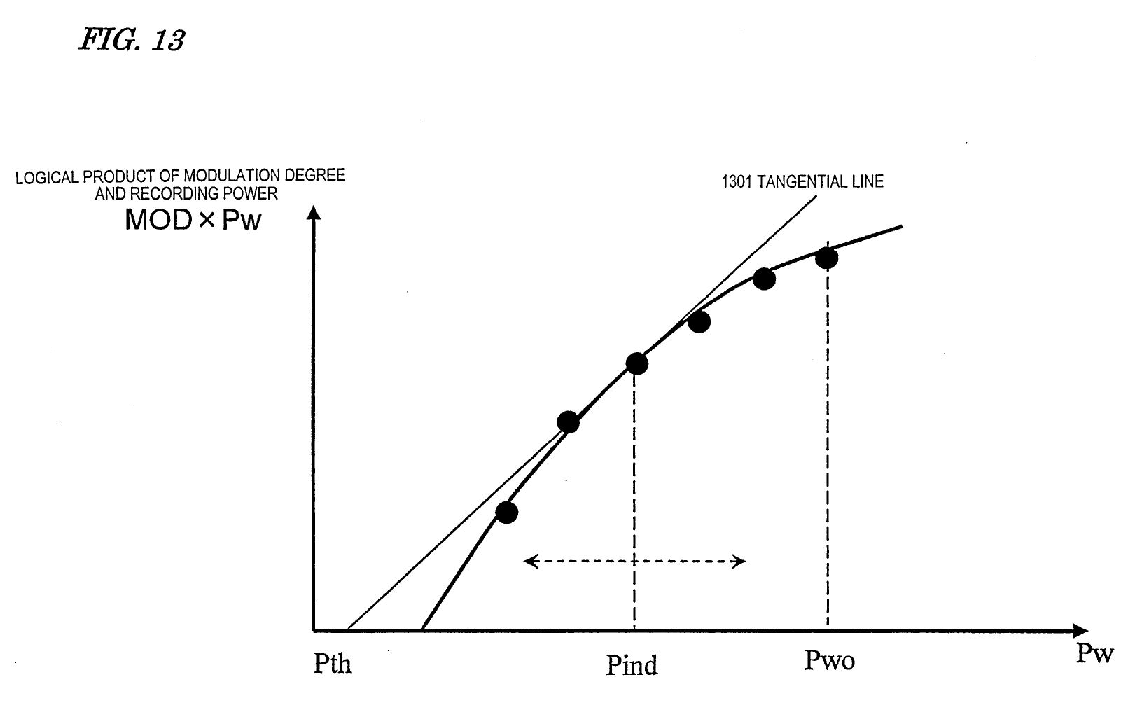

Now, a method for finding the optimal recording power, which is the optimal value of the recording power, from the modulation signal degree with respect to the plurality of recording powers will be described. Based on the measurement results of the modulation signal degree with respect to the plurality of recording powers used for the test recording, the calculation means 119 calculates a logical product of each recording power (Pw) and the modulation signal degree (MOD) with respect to the respective recording power (Pw). FIG. 13 illustrates an example of a logical product of a recording power (Pw) and the modulation signal degree with respect to the recording power (MOD×Pw). A tangential line 1301 is drawn using a plurality of measuring points in the vicinity of the target recording power (Pind). The intercept of the tangential line 1301 and the x axis (power axis) is set as the threshold recording power (Pth). The optimal recording power (Pwo) is calculated using the threshold recording power (Pth) and the power multiplication factors ρ and κ, κ, ρ and Pind are the OPC parameters mentioned above and are already recorded in the disc management area. The optimal recording power (Pwo) is calculated by the expression of Pwo=ρ×κ×Pth. The calculation result is the optimal recording power Pwo of the respective information recording layer.

Next, the calculation means checks whether the optimal recording power found in the OPC-A area is the proper optimal recording power which is to be found. The optimal recording power (Pwoi) found in the OPC-A area of the i'th layer using the optical disc apparatus in the above-described operation procedure of finding the optimal recording power is compared with the recommended recording power (Pwpi) for the i'th layer determined by the optical disc manufacturer at the time of production. When the optimal recording power (Pwoi) is higher than the recommended recording power (Pwpi) by, for example, a level equal to or more than 5% (Pwoi/Pwpi−1≧5%), the found optimal recording power (Pwoi) is determined to be inappropriate and the write strategy is changed. Or, the OPC procedure described above is re-performed with the same write strategy in another attempt to find an optimal recording power (Pwoi).

There is another method for checking. In order to avoid such a situation that the optimal recording power found in the OPC-A area using the optical disc apparatus during the above-described operation procedure of finding the optimal recording power is substantially higher than the recording power assumed by the manufacturer of the optical disc at the time of production, the following is performed. The target modulation signal degree (Mmax) between the optimal recording power and the recommended recording power read from the disc management information pre-recorded in the PIC area of the optical disc is compared with the modulation signal degree (Mo) of the signal recorded with the optimal recording power. When the modulation signal degree of the signal recorded with the optimal recording power is higher than the target modulation signal degree (Mmax) (i.e., Mo>Mmax), the found optimal recording power (Pwoi) is determined to be too high and the write strategy is changed. Or, the OPC procedure described above is re-performed with the same write strategy in another attempt to find an optimal recording power (Pwoi). When it is determined as a result of the comparison that the modulation signal degree of the signal recorded with the optimal recording power (Mo) is equal to or lower than the target modulation signal degree (Mmax) (i.e., Mo≦Mmax), the found optimal recording power (Pwoi) is determined to be the optimal recording power.

The above examples, which are described as the methods for checking the optimal recording power, may be combined, or another preferable method may be used. For example, jitter, MLSE, β, asymmetry and the like may be combined to be used as a determination basis.

In Embodiment 8, the optimal value of the recording power is found by measuring the modulation signal degree of the signals recorded with a plurality of recording powers. The optimal recording power is not limited to be found by measuring the modulation signal degree. The optimal recording power may be found by measuring one of, or a combination of two or more of, other signal indices such as β, jitter, asymmetry, MLSE and the like. In the case of finding the optimal recording power using the modulation signal degree, the optimal value of the recording power may be found using an n·κ method, instead of using the logical product of the modulation signal degree and the recording power. By the n·κ method, the optimal value of the recording power is found using a logical product of the modulation signal degree and the power of n of the recording power.

Now, an operation of the calculation means for making a preparation for test recording on the j'th layer, which is different from the i'th layer, will be described. The ratio α (=Pwoi/Pwpi) between the optimal recording power (Pwoi) and the recommended recording power (Pwpi) for the i'th information recording layer is found, and the optimal recording power predicted for the j'th information recording layer (Pwyj) is calculated from the recommended recording power (Pwpi) for the j'th information recording layer using the following expression.

(Pwyj)=(Pwpj)×α

A value obtained by multiplying the optimal recording power predicted for the j'th information recording layer (Pwyj) by a predetermined coefficient X (for example, 1.1) is determined as the upper limit recording power for the j'th layer (Pwmaxj).

(Pwmaxj)=(Pwyj)×X

In the above, α is the ratio between the optimal recording power found by the test recording and the recommended recording power. Namely, α is an index indicating how much the absolute value of the recording power which is set by the optical disc apparatus is deviated from the recommended recording power determined by the disc manufacturer at the time of production, due to dirt, dust or any other distortion caused to the optical disc apparatus. When α=1, the found optimal recording power matches the recommended recording power, namely, the recording power found by performing the test recording using the optical disc apparatus matches the power pre-recorded by the disc manufacturer at the time of production. When α>1, for example, dirt, dust or the like adheres to an element of an optical system, for example, an objective lens of the optical disc apparatus, and as a result, the recording power on the optical disc face is lower than the recording power immediately after laser beam is emitted, due to a loss caused in the middle of the optical path. Or, when α>1, there may be an error in the calibration of the recording power performed by the optical disc apparatus. When α>1 is caused for such a reason, substantially the same loss of the recording power or calibration error also occurs in the other information recording layers. Therefore, the ratio α is used to correct an error between the recording power which is set by the optical disc apparatus and the actual power irradiating the information recording face of the optical disc.

Next, the system control means 121 instructs the recording power control means 116 to perform test recording in the OPC-B area of the j'th information recording layer and to find the optimal recording power and the optimal recording pulse conditions for the j'th layer. The test recording is performed at a plurality of recording powers equal to or lower than the upper limit recording power (Pwmaxj). The reproduction signal detection means 117 measures the modulation signal degree characteristics of the reproduction signals of the RF signal which are output from the RF signal generation means 113.

The calculation means 119 finds the optimal recording power (Pwoj) for the j'th information recording layer. After the optimal recording power (Pwoj) for the j'th information recording layer is determined, test recording is performed in the OPC-B area of the j'th information recording layer to find optimal values of the recording pulse conditions (write strategy conditions). Thus, the test recording on the j'th information recording layer is completed. Although omitted here, the system control means 121 may perform a process of checking whether the found optimal recording power (Pwoj) is the proper optimal recording power which is to be found.

The system control means 121 checks whether the test recording is completed on all the information recording layers. When the test recording is not completed on all the information recording layers, the test recording is performed on the remaining information recording layer(s) to find the optimal recording power and the optimal values of the write strategy conditions. When test recording is completed on all the information recording layers, test recording completion processing is performed. Namely, the system control means instructs the recording power setting means to update the Next Available PSN information in the DMA, and performs recording in the DMA. Thus, the test recording is finished.

Information such as the optimal recording power found by test recording performed by the optical disc recording/reproduction apparatus, the upper limit value of the recording power for recording in an OPC-B area, the modulation signal degree which is to be the upper limit of the recording power, the optimal value of the recording pulse conditions or the like may be written in the area 1002 for DMA in the inner zone or any other prescribed area. Where such information is written, the next time when an operation on the optical information recording medium is started, the recording power or the recording pulse conditions can be corrected in accordance with the characteristics of the optical information recording medium without performing adjustment steps, which are otherwise necessary. This can shorten the adjustment time and efficiently improve the signal quality of the recording marks.

In the above embodiments, the present invention is described with an optical recording/reproduction apparatus and a write-once optical disc, as an example. The present invention is not limited to these and is also applicable to a rewritable optical disc.

In the above embodiments of the present invention, the upper limit on the recording power for recording in an OPC-B area is set. The “recording power” generally means the peak level power obtained when laser beam is modulated into pulses. In accordance with the type of recording pulses, the upper limit may be set for a power level lower than the write peak power, such as middle power, space power, erase power, bottom power, cooling power or the like. A plurality of upper limits can be set in accordance with the speed of the optical disc. Specifically, in the case of an optical disc recordable both at a double speed (2×) and a four speed (4×), different upper limits can be set for the recording power for 2× and 4×.

For the zeroth information recording layer which is located farthest from the laser beam incidence side of an optical disc including a plurality of information recording layers, no upper limit needs to be set because it is not necessary to consider the influence on any information recording layer farther from the laser beam incidence side than this information recording layer. An upper limit on the recording power needs to be set only for the first information recording layer and the information recording layer(s) closer to the laser beam incidence side than the first information recording layer. Accordingly, in the zeroth information recording layer (L0) in the above embodiments, the OPC-B area may be replaced with an OPC-A area.

In the above embodiments of the present invention, the OPC-B areas are located at generally the same radial position among the information recording layers. Since recording is not performed in the OPC-B areas according to the present invention at an excessively high recording power, the OPC-B areas may be positionally exchanged with a DMA or any other area, in the inner zone or the outer zone, in which recording is performed at an appropriate power, so that the OPC-B areas are located at shifted radial positions among the information recording layers. Alternatively, an OPC-B area in one information recording layer may be divided into two or more to be located both in the inner zone and the outer zone.

In the above embodiments of the present invention, two types of OPC areas are located in the inner zone. The OPC area may be located in the outer zone instead of the inner zone, or may be located both in the inner zone and the outer zone. The test recording area may be located in the data zone. In the outer zone, either the OPC-A area or the OPC-B area may be located. By locating the OPC area both in the inner zone and the outer zone, the following is made possible. When high speed recording by which the rotation rate of the spindle motor at the inner radius exceeds 10,000 rpm is performed, even if test recording cannot be performed at a desired line rate due to the restriction on the rotation rate in the inner zone on the inner periphery side, test recording can be performed in the outer zone on the outer periphery side because the rotation rate is half of that in the inner zone. Thus, it is made possible to perform optimal recording power learning or other types of learning on the outer periphery side.

In the above embodiments of the present invention, an optical pickup substantially the same as the optical pickup used for BD is used. Alternatively, an optical pickup of any structure is usable as long as an optical recording medium is irradiated with a beam and a signal is output in accordance with the beam reflected by the optical recording medium.

In the above embodiments of the present invention, an optical disc including four stacked information recording layers is described as an example. The present invention is applicable to a multilayer optical disc including three, two, or five or more layers, instead of four layers, needless to say.

The optical recording/reproduction method and the optical recording/reproduction apparatus for an optical disc according to the present invention provide an effect of realizing high density recording on an optical recording medium, and are usable for, for example, the electric/electronics appliance industry including digital home appliances and information processing apparatuses.

What is claimed is:

1. A multilayer optical information recording medium including a plurality of information recording layers, wherein:
each of the information recording layers includes an inner zone, a data zone and an outer zone located along a radial direction from an inner periphery thereof;
the plurality of information recording layers include a first information recording layer, and second through N'th information recording layers (N is an integer of two or larger) which are provided closer to a laser beam incidence side than the first information recording layer and sequentially located from the side closer to the first recording layer;
at least one of the first through N'th information recording layers includes a reproduction-only management data area (control data area) pre-formed at the time of production of the disc;
each of the first through N'th information recording layers in at least one of the inner zone and the outer zone includes at least one category of test recording area among at least two categories of test recording areas (OPC-A area and OPC-B area) for performing test recording for data recording and/or reproduction conditions; and
in the OPC-B area, an upper limit value is set on a recording power for the test recording.

2. The multilayer optical information recording medium of claim 1, wherein in the OPC-B area, the test recording is performed after the test recording is performed in the OPC-A area of any one of the first through N'th information recording layers.

3. The multilayer optical information recording medium of claim 1, wherein the upper limit value in the OPC-B area is set based on a ratio between:
an optimal recording power which is found in the OPC-A area of at least one of the first through N'th information recording layers, and
a recommended recording power which is pre-recorded in the management data area.

4. The multilayer optical information recording medium of claim 1, wherein the OPC-A areas of M'th (M is an integer of equal to or larger than 1 and equal to or smaller than N) through N'th information recording layers, among the first through N'th information recording layers, are partially or entirely located physically at generally the same radial position in an overlapped manner with one another.

5. The multilayer optical information recording medium of claim 4, wherein M is M=1 or M=2.

6. The multilayer optical information recording medium of claim 1, wherein the management data (control data) area is partially or entirely overlapped with the OPC-B area in terms of physical radial position thereof.

7. The multilayer optical information recording medium of claim 1, wherein the test recording area of the first information recording layer has a physical size larger than the physical size of the OPC-A area of each of the second through N'th information recording layers.

8. The multilayer optical information recording medium of claim 1, wherein the OPC-B area has a physical size larger than the physical size of the OPC-A area in the same information recording layer as the OPC-B area.

9. The multilayer optical information recording medium of claim 1, wherein in the management data area, an upper limit value of the recording power for the test recording in the OPC-B area is pre-recorded.

10. The multilayer optical information recording medium of claim 1, wherein in the management data area, an upper limit value of a modulation signal degree with which recording can be performed in the OPC-B area, or a modulation signal degree regarding the recommended recording power is pre-recorded.

11. The multilayer optical information recording medium of claim 1, which is a write-once optical disc.

12. A recording method for a multilayer optical information recording medium including a plurality of information recording layers, in which each of the information recording layers includes an inner zone, a data zone and an outer zone located along a radial direction from an inner periphery thereof; the plurality of information recording layers include a first information recording layer, and second through N'th information recording layers (N is an integer of two or larger) which are provided closer to a laser beam incidence side than the first information recording layer and sequentially located from the side closer to the first recording layer; at least one of the first through N'th information recording layers includes a reproduction-only management data area (control data area) pre-formed at the time of production of the disc, and a recordable or rewritable management data area (DMA); each of the first through N'th information recording layers in at least one of the inner zone and the outer zone includes at least one category of test recording area among at least two categories of test recording areas (OPC-A area and OPC-B area) for performing test recording for data recording and/or reproduction conditions; and in the OPC-B area, an upper limit value is set on a recording power for the test recording, the method comprising the steps of:
reading a recommended power pre-recorded at the time of production of the disc from the control data area;
reading OPC area management information from the DMA;
determining that a recordable OPC-A area is an i'th (i is an integer of 1 through N) information recording layer based on the OPC area management information;
performing test recording in the OPC-A area of the i'th information recording layer and determining an optimal recording power for the i'th information recording layer;
calculating a ratio (α) between the optimal recording power of the i'th information recording layer and the recommended recording power, calculating a predicted optimal recording power, which is an optimal recording power predicted for an information recording layer other than the i'th information recording layer, and calculating an upper limit value on the recording power for test recording in the OPC-B area in the information recording layer other than the i'th information recording layer based on the predicted optimal recording power; and
performing the test recording at a recording power equal to or lower than the upper limit value in the OPC-B area of an arbitrary j'th (j≠i and j is an integer of 1 through N) information recording layer other than the i'th information recording layer, and determining an optimal recording power for the arbitrary j'th information recording layer.

13. The recording method for the multilayer optical information recording medium of claim 12, wherein in the OPC-B area, the test recording is performed after the test recording is performed in the OPC-A area of any one of the first through N'th information recording layers.

14. The recording method for the multilayer optical information recording medium of claim 12, wherein the upper limit value in the OPC-B area is set using a ratio (α) between:
an optimal recording power which is found in the OPC-A area of the i'th information recording layer, which is at least one of the first through N'th information recording layers, and
a recommended recording power which is pre-recorded in the management data area; and
based on a value obtained by expression (1):
the predicted optimal power for the j'th layer=α×the recommended recording power for the j'th layer×X (1).

15. The recording method for the multilayer optical information recording medium of claim 14, wherein X is 1.1

16. The recording method for the multilayer optical information recording medium of claim 12, wherein the test recording in the OPC-A areas in the information recording layers is sequentially performed in the order from the OPC-A area of the layer farthest from the laser incidence side to the OPC-A area of the layer closest to the laser incidence side among the recordable OPC-A areas.

17. The recording method for the multilayer optical information recording medium of claim 12, wherein the test recording in the OPC-B areas in the information recording layers is performed in an arbitrary order among recordable OPC-B areas.

18. The recording method for the multilayer optical information recording medium of claim 12, wherein the optical information recording medium including the plurality of information recording layers is a write-once optical disc.

19. A recording/reproduction apparatus for a multilayer optical information recording medium, comprising:
light irradiation means for irradiating, with laser beam, each information recording layer of the multilayer optical information recording medium including a plurality of information recording layers to record data to, and reproduce data from, the information recording layer;
management information reading means for reading a recommended recording power pre-recorded in a reproduction-only disc management area of the multilayer information recording medium at the time of production thereof, and recordable or rewritable OPC area management information;
recording power control means for controlling a laser power of the laser beam irradiating each information recording layer of the multilayer optical information recording medium to perform test recording at a plurality of recording powers;
reproduction signal detection means for detecting a signal quality of a reproduction signal obtained from light reflected by the multilayer optical information recording medium; and
calculation means for calculating an optimal recording power, which is an optimal value of the recording power, from a value detected by the reproduction signal detection means, calculating a ratio (α) between the optimal recording power and the recommended recording power, and calculating a predicted optimal recording power, which is an optimal recording power predicted for an arbitrary information recording layer.

20. The recording/reproduction apparatus of claim 19, comprising memory means for storing any one of, or all of, the optimal recording power for each information recording layer determined by the test recording, the ratio (α), and the predicted optimal recording power.
